(19) United States
(12) Patent Application Publication
(10) Pub. No.: US 2013/0188716 A1
(43) Pub. Date: Jul. 25, 2013

(54) TEMPORAL MOTION VECTOR PREDICTOR CANDIDATE

(71) Applicant: QUALCOMM INCORPORATED, San Diego, CA (US)

(72) Inventors: Vadim Seregin, San Diego, CA (US); Xianglin Wang, San Diego, CA (US); Jianle Chen, San Diego, CA (US); Marta Karczewicz, San Diego, CA (US)

(73) Assignee: QUALCOMM INCORPORATED, San Diego, CA (US)

(21) Appl. No.: 13/744,197

(22) Filed: Jan. 17, 2013

Related U.S. Application Data
(60) Provisional application No. 61/589,213, filed on Jan. 20, 2012.

(51) Int. Cl. H04N 7/26

(52) U.S. Cl. CPC H04N 19/00569
USPC 375/240.16

(57) ABSTRACT

The techniques of this disclosure may be generally related to temporal motion vector prediction candidate. A video coder may determine a temporal motion vector prediction candidate for a plurality of blocks only once. Each of the plurality of blocks may include different spatial motion vector prediction candidates, but the temporal motion vector prediction candidate for the plurality of blocks may be the same.

This application claims the benefit of U.S. Provisional Application 61/589,213 filed Jan. 20, 2012, the entire content of which is incorporated by reference herein.

### TECHNICAL FIELD

This disclosure relates to video coding and, more particularly, to techniques related to temporal motion vector prediction candidate.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

The techniques described in this disclosure are generally related to determining motion information for a temporally neighboring block that is to be included in a list of candidate motion vector predictors. A video coder may determine the motion vector for a block that temporally neighbors a plurality of blocks (e.g., is co-located with the plurality of blocks), and include this motion information in lists of candidate motion vector predictors for each of the plurality of blocks. In some examples, the motion information for spatially neighboring blocks for at least two of the plurality of blocks may be different in respective lists of candidate motion vector predictors, but the motion information for the temporally neighboring block may be the same in respective lists of candidate motion vector predictors for all of the plurality of blocks.

Furthermore, in some examples, the video coder may not use the reference index or indices of the motion vector or vectors of the temporally neighboring block for inter-prediction purposes. Rather, the video coder may derive the reference index or indices based on a spatially neighboring block. In some examples, the video coder may evaluate reference indices in both reference picture lists for the spatially neighboring block. For instance, if a reference index into one of the reference picture lists is not available, the video coder may determine whether the reference index is available in the other reference picture list.

In one example, the disclosure describes a method for coding video data. The method includes determining motion information for a block in a temporal picture. In this example, the block in the temporal picture temporally neighbors a plurality of blocks in a current picture. The method also includes determining motion information for a first block that spatially neighbors a first block of the plurality of blocks, and including the motion information, if available, for the first block that spatially neighbors the first block of the plurality of blocks and the motion information for the block in the temporal picture in a first list of candidate motion vector predictors for the first block of the plurality of blocks. The method further includes determining motion information for a second, different block that spatially neighbors a second, different block of the plurality of blocks, and including the motion information, if available, for the second block that spatially neighbors the second block of the plurality of blocks and the motion information for the block in the temporal picture in a second, different list of candidate motion vector predictors for the second block of the plurality of blocks. The method also includes coding the first block of the plurality of blocks based on the first list of candidate motion vector predictors, and coding the second block of the plurality of blocks based on the second list of candidate motion vector predictors.

In one example, the disclosure describes a device for coding video data. The device includes a video coder configured to determine motion information for a block in a temporal picture. In this example, the block in the temporal picture temporally neighbors a plurality of blocks in a current picture. The video coder is also configured to determine motion information for a first block that spatially neighbors a first block of the plurality of blocks, and include the motion information, if available, for the first block that spatially neighbors the first block of the plurality of blocks and the motion information for the block in the temporal picture in a first list of candidate motion vector predictors for the first block of the plurality of blocks. The video coder is further configured to determine motion information for a second, different block that spatially neighbors a second, different block of the plurality of blocks, and include the motion information, if available, for the second block that spatially neighbors the second block of the plurality of blocks and the motion information for the block in the temporal picture in a second, different list of candidate motion vector predictors for the second block of the plurality of blocks. The video coder is also configured to code the first block of the plurality of blocks based on the first list of candidate motion vector predictors, and code the second block of the plurality of blocks based on the second list of candidate motion vector predictors.

In one example, the disclosure describes a device for coding video data, the device includes means for determining motion information for a block in a temporal picture. In this example, the block in the temporal picture temporally neighbors a plurality of blocks in a current picture. The device also includes means for determining motion information for a first block that spatially neighbors a first block of the plurality of blocks, and means for including the motion information, if available, for the first block that spatially neighbors the first block of the plurality of blocks and the motion information for the block in the temporal picture in a first list of candidate motion vector predictors for the first block of the plurality of blocks. The device further includes means for determining motion information for a second, different block that spatially neighbors a second, different block of the plurality of blocks, and means for including the motion information, if available, for the second block that spatially neighbors the second block of the plurality of blocks and the motion information for the block in the temporal picture in a second, different list of candidate motion vector predictors for the second block of the plurality of blocks. The device also includes means for coding the first block of the plurality of blocks based on the first list of candidate motion vector predictors, and means for coding the second block of the plurality of blocks based on the second list of candidate motion vector predictors.

In one example, the disclosure describes a computer-readable storage medium having stored thereon instructions that cause one or more processors to determine motion information for a block in a temporal picture. In this example, the block in the temporal picture temporally neighbors a plurality of blocks in a current picture. The instructions also cause the one or more processors to determine motion information for a first block that spatially neighbors a first block of the plurality of blocks, and include the motion information, if available, for the first block that spatially neighbors the first block of the plurality of blocks and the motion information for the block in the temporal picture in a first list of candidate motion vector predictors for the first block of the plurality of blocks. The instructions further cause the one or more processors to determine motion information for a second, different block that spatially neighbors a second, different block of the plurality of blocks, and include the motion information, if available, for the second block that spatially neighbors the second block of the plurality of blocks and the motion information for the block in the temporal picture in a second, different list of candidate motion vector predictors for the second block of the plurality of blocks. The instructions also cause the one or more processors to code the first block of the plurality of blocks based on the first list of candidate motion vector predictors, and code the second block of the plurality of blocks based on the second list of candidate motion vector predictors.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2A is a block diagram illustrating an example of a block that is to be predicted and spatially and temporally neighboring blocks of the block that is to be predicted.

FIG. 2B is a conceptual diagram illustrating an example of a list of candidate motion vector predictors for the block of FIG. 2A that is to be predicted.

FIGS. 3A-3I are conceptual diagrams illustrating a location of a temporally neighboring block that is fixed.

FIGS. 4A-4D are conceptual diagrams illustrating a location of a temporally neighboring block that is based on the arrangement of the plurality of blocks.

FIG. 5 is a block diagram illustrating an example video encoder that may implement the techniques described in this disclosure.

FIG. 6 is a block diagram illustrating an example video decoder that may implement the techniques described in this disclosure.

FIG. 7 is a flowchart illustrating an example operation in accordance with one or more example techniques described in this disclosure.

FIG. 8 is a flowchart illustrating another example operation in accordance with one or more example techniques described in this disclosure.

FIG. 9 is a flowchart illustrating another example operation in accordance with one or more example techniques described in this disclosure.

### DETAILED DESCRIPTION

A video coder may implement a merge/skip mode or an advance motion vector prediction (AMVP) mode for coding a video block. As described in more detail, in merge/skip mode or AMVP mode, the video coder utilizes a motion vector predictor to determine the motion vector for a block that is to be inter-predicted. One example of the motion vector predictor is a temporal motion vector predictor (TMVP).

The TMVP refers to a motion vector of a temporally neighboring block. The temporally neighboring block resides within a picture other than the picture that includes the block being inter-predicted. The TMVP may be a co-located block of a different picture than that associated with the video block being coded, although other non-co-located blocks might also be used. In general, determining the TMVP for a block may be a complex and processing intensive task for the video coder.

As described in more detail, in accordance with the techniques described in this disclosure, the video coder may determine a common TMVP for a plurality of blocks. For example, the video coder may determine motion information for a block that temporally neighbors the plurality of blocks only once. The motion information for the block that temporally neighbors the plurality of blocks may include one or more of the motion vector information of the block that temporally neighbors the plurality of blocks and the reference index or indices for the motion vector or vectors of the block that temporally neighbors the plurality of blocks. In this manner, the video coder may not need to separately determine a TMVP for each of the blocks of the plurality of blocks. Accordingly, in some examples, the techniques may reduce processing time in determining TMVPs for each of the blocks, as compared to other techniques.

For example, the video coder may determine the common TMVP for the plurality of blocks once, and include this common TMVP in the list of candidate motion vector predictors for each of the blocks. By determining a common TMVP for a plurality of blocks, the techniques described in this disclosure may promote efficient coding of video blocks.

In merge/skip mode, the video coder may also determine the reference index for the common TMVP. For example, the reference index for the TMVP may identify a picture in a first reference picture list or a picture in a second reference picture list. In some examples, rather than using the reference index for the TMVP, the video coder may derive the reference index for the TMVP.

For example, the video coder may determine whether a spatially neighboring block is inter-predicted. If the spatially neighboring block is inter-predicted, the video coder may utilize the reference index of the motion vector of the spatially neighboring block as the reference index of the TMVP.

In examples where the temporally neighboring block is bi-predicted (i.e., predicted with two motion vectors that refer to different reference picture lists), there may be two TMVPs, one for each motion vector. If the temporally neighboring block is bi-predicted with two TMVPs, and the spatially neighboring block, whose reference index is used to determine the reference index of the TMVP, is uni-predicted, the video coder may set the reference index of the motion vector of the uni-predicted spatially neighboring block as the reference index for both of the TMVPs.

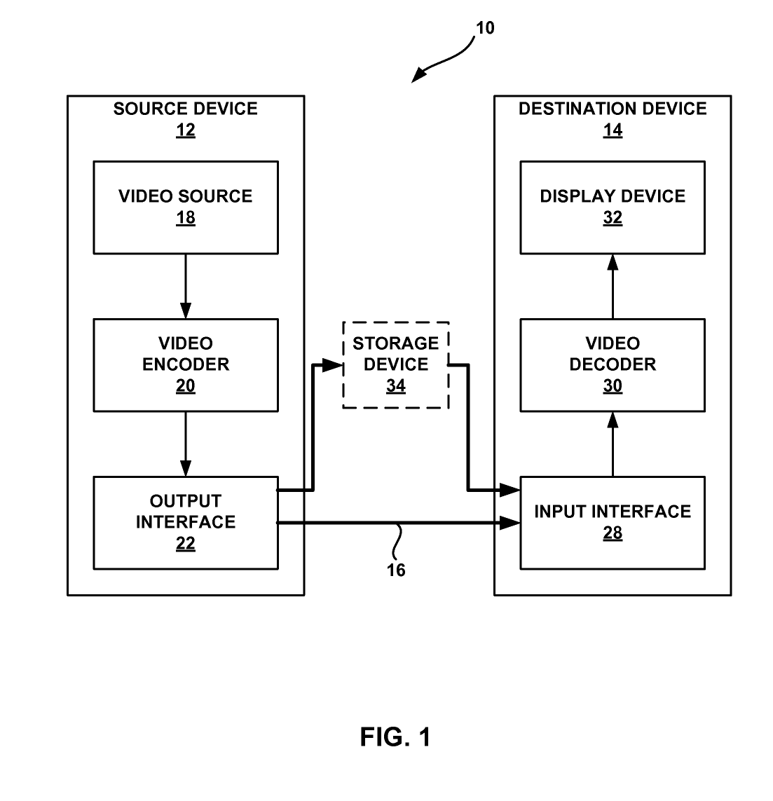

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 34. Similarly, encoded data may be accessed from storage device 34 by input interface. Storage device 34 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 34 may correspond to a file server or another intermediate storage device that may hold the encoded video generated by source device 12. Destination device 14 may access stored video data from storage device 34 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 34 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 12. The encoded video data may be transmitted directly to destination device 14 via output interface 22 of source device 12. The encoded video data may also (or alternatively) be stored onto storage device 34 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 34, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). The latest Working Draft (WD) of HEVC, and referred to as HEVC WD9 hereinafter, is available, as of Jan. 10, 2013, from http://phenix.int-evry.fr/jct/doc_end_user/documents/11_Shanghai/wg11/JCTVC-K1003-v13.zip, the entire content of which is incorporated by reference herein. Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. Other examples of video compression standards include MPEG-2 and ITU-T H.263.

The techniques of this disclosure, however, are not limited to any particular coding standard. Moreover, even if the techniques described in this disclosure may not necessarily conform to a particular standard, the techniques described in this disclosure may further assist in coding efficiency relative to the various standards. Also the techniques described in this disclosure may be part of future standards. For ease of understanding, the techniques are described with respect to the HEVC standard under development, but the techniques are not limited to the HEVC standard, and can be extended to other video coding standards or video coding techniques that are not defined by a particular standard.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, computer-readable storage medium such as a non-transitory computer-readable storage medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU corresponds to a size of the coding node and may be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., RefPicList0 (L0) or RefPicList1 (L1)) for the motion vector.

A TU may be used for the transform and quantization processes. A given CU having one or more PUs may also include one or more transform units (TUs). Following prediction, video encoder 20 may calculate residual values corresponding to the PU. The residual values comprise pixel difference values that may be transformed into transform coefficients, quantized, and scanned using the TUs to produce serialized transform coefficients for entropy coding. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

For example, for video coding according to the high efficiency video coding (HEVC) standard currently under development, a video picture may be partitioned into coding units (CUs), prediction units (PUs), and transform units (TUs). A CU generally refers to an image region that serves as a basic unit to which various coding tools are applied for video compression. A CU typically has a square geometry, and may be considered to be similar to a so-called “macroblock” under other video coding standards, such as, for example, ITU-T H.264.

To achieve better coding efficiency, a CU may have a variable size depending on the video data it contains. That is, a CU may be partitioned, or “split” into smaller blocks, or sub-CUs, each of which may also be referred to as a CU. In addition, each CU that is not split into sub-CUs may be further partitioned into one or more PUs and TUs for purposes of prediction and transform of the CU, respectively.

PUs may be considered to be similar to so-called partitions of a block under other video coding standards, such as H.264. PUs are the basis on which prediction for the block is performed to produce “residual” coefficients. Residual coefficients of a CU represent a difference between video data of the CU and predicted data for the CU determined using one or more PUs of the CU. Specifically, the one or more PUs specify how the CU is partitioned for the purpose of prediction, and which prediction mode is used to predict the video data contained within each partition of the CU.

One or more TUs of a CU specify partitions of a block of residual coefficients of the CU on the basis of which a transform is applied to the block to produce a block of residual transform coefficients for the CU. The one or more TUs may also be associated with the type of transform that is applied. The transform converts the residual coefficients from a pixel, or spatial domain to a transform domain, such as a frequency domain. In addition, the one or more TUs may specify parameters on the basis of which quantization is applied to the resulting block of residual transform coefficients to produce a block of quantized residual transform coefficients. The residual transform coefficients may be quantized to possibly reduce the amount of data used to represent the coefficients.

A CU generally includes one luminance component, denoted as Y, and two chrominance components, denoted as U and V. In other words, a given CU that is not further split into sub-CUs may include Y, U, and V components, each of which may be further partitioned into one or more PUs and TUs for purposes of prediction and transform of the CU, as previously described. For example, depending on the video sampling format, the size of the U and V components, in terms of a number of samples, may be the same as or different than the size of the Y component. As such, the techniques described above with reference to prediction, transform, and quantization may be performed for each of the Y, U, and V components of a given CU.

To encode a CU, one or more predictors for the CU are first derived based on one or more PUs of the CU. A predictor is a reference block that contains predicted data for the CU, and is derived on the basis of a corresponding PU for the CU, as previously described. For example, the PU indicates a partition of the CU for which predicted data is to be determined, and a prediction mode used to determine the predicted data. The predictor can be derived either through intra-(I) prediction (i.e., spatial prediction) or inter-(P or B) prediction (i.e., temporal prediction) modes. Hence, some CUs may be intra-coded (I) using spatial prediction with respect to neighboring reference blocks, or CUs, in the same frame, while other CUs may be inter-coded (P or B) with respect to reference blocks, or CUs, in other frames.

Upon identification of the one or more predictors based on the one or more PUs of the CU, a difference between the original video data of the CU corresponding to the one or more PUs and the predicted data for the CU contained in the one or more predictors is calculated. This difference, also referred to as a prediction residual, comprises residual coefficients, and refers to pixel differences between portions of the CU specified by the one or more PUs and the one or more predictors, as previously described. The residual coefficients are generally arranged in a two-dimensional (2-D) array that corresponds to the one or more PUs o the CU.

To achieve further compression, the prediction residual is generally transformed, e.g., using a discrete cosine transform (DCT), integer transform, Karhunen-Loeve (K-L) transform, or another transform. The transform converts the prediction residual, i.e., the residual coefficients, in the spatial domain to residual transform coefficients in the transform domain, e.g., a frequency domain, as also previously described. The transform coefficients are also generally arranged in a 2-D array that corresponds to the one or more TUs of the CU. For further compression, the residual transform coefficients may be quantized to possibly reduce the amount of data used to represent the coefficients, as also previously described.

As described above, the techniques described in this disclosure determine motion information for a temporally neighboring block that temporally neighbors the plurality of blocks. For example, the motion information may include the motion vector information (e.g., information for the motion vector or vectors). As another example, the motion information may include the motion vector information and reference index information (e.g., information for the reference index or indices that identify the reference picture to which the motion vector or vectors of the block refer).

In some examples, the plurality of blocks may form a CU, and each block may be a PU within the CU. In these examples, the techniques may determine the motion information for a block that temporally neighbors the CU, and include this motion information (e.g., the motion vector information or the motion vector information and the reference index information) in the lists of candidate motion vector predictors for each PU within the CU, rather than determining motion information for temporally neighboring blocks of each PU within the CU. As another example, the plurality of block may form an LCU, and each block may be a CU. In these examples, the techniques may determine the motion information for a block that temporally neighbors the LCU, and include this motion information in the lists of candidate motion vector predictors for each CU within the LCU, rather than determining motion information for temporally neighboring blocks of each CU within the LCU.

To achieve still further compression, an entropy coder subsequently encodes the resulting residual transform coefficients, using Context Adaptive Variable Length Coding (CAVLC), Context Adaptive Binary Arithmetic Coding (CABAC), Probability Interval Partitioning Entropy Coding (PIPE), or another entropy coding methodology. Entropy coding may achieve this further compression by reducing or removing statistical redundancy inherent in the video data of the CU, represented by the coefficients, relative to other CUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 and video decoder 30 may be configured in accordance with techniques of this disclosure. For example, as described above, video encoder 20 and video decoder 30 may be configured to implement the merge mode or advance motion vector prediction (AMVP) mode. In merge mode and AMVP mode, video encoder 20 and video decoder 30 may be configured to determine a motion vector or vectors for the current block based on a motion vector or vectors of another block. The motion vector or vectors of another block may be motion vector or vectors of a spatially neighboring block or a temporally neighboring block. Spatially neighboring blocks refer to blocks that neighbor the current block, and are in the same picture as the current block. Temporally neighboring blocks refer to blocks that neighbor the current block, but are in a different picture. For example, spatially neighboring blocks neighbor the current block in the same picture. Temporally neighboring blocks neighbor the current block across pictures that represent different time instances of the video.

One example of a temporally neighboring block is a block that is co-located as the blocks in the picture that includes the current block that is being inter-predicted. However, the temporally neighboring block need not necessarily be co-located in every example. As another example, the temporally neighboring block may be located at the bottom-right of the blocks in the picture that includes the current block that is being inter-predicted, but in a different picture than the picture that includes the current block.

To implement merge mode and AMVP mode, video encoder 20 and video decoder 30 each construct a list of candidate motion vector predictors. This list of candidate of motion vector predictors includes motion information for the spatially neighboring blocks and the temporally neighboring blocks. Video encoder 20 and video decoder 30 may each construct a list of candidate motion vector predictors for each block of a plurality of blocks. As one example, video encoder 20 and video decoder 30 may construct a list of candidate motion vector predictors for each PU within a CU. As another example, video encoder 20 and video decoder 30 may construct a list of candidate motion vector predictors for each CU within an LCU.

Although the techniques described in this disclosure are described with examples for PUs within a CU, or CUs with an LCU, the techniques described in this disclosure are not so limited. In general, the techniques described in this disclosure are extendable to any group of blocks. For example, video encoder 20 and video decoder 30 may construct a list of candidate motion vector predictors for each block of a plurality of blocks. In one example, each block may be a PU, and the plurality of blocks may form a CU. In another example, each block may be a CU, and the plurality of blocks may form an LCU. In still other examples, the techniques may be applied to macroblocks defined in a manner similar to macroblocks of the ITU H-264 standard, sub-blocks, partitions, or other types of video blocks used in a video coding process.

To construct the list of candidate motion vector predictors for a block within the plurality of blocks, video encoder 20 and video decoder 30 evaluate the motion information for spatially neighboring blocks, and include the motion information in the list of candidate motion vector predictors. In some examples, one or more of the spatially neighboring blocks may not be inter-predicted, but rather intra-predicted. Accordingly, video encoder 20 and video decoder 30 may include the motion information, if available, for the spatially neighboring blocks in the list of candidate motion vector predictors. As described in more detail, in some examples, rather than evaluating the motion information for each temporally neighboring block of a block, video encoder 20 and video decoder 30 may evaluate the motion information for a temporally neighboring block that neighbors the plurality of blocks. For example, rather than evaluating the motion information for each block that temporally neighbors each PU in a CU, video encoder 20 and video decoder 30 may evaluate the motion information for a block that temporally neighbors the CU. As another example, rather than evaluating the motion information for each block that temporally neighbors each CU in an LCU, video encoder 20 and video decoder 30 may evaluate the motion information for a block that temporally neighbors the LCU.

Video encoder 20 and video decoder 30 may include the motion information for the block that temporally neighbors the plurality of blocks in each list of candidate motion vector predictors for each block. In this manner, the list of candidate motion vector predictors for a first block of the plurality of blocks may include motion information for blocks that spatially neighbor the first block, if available, and include motion information for the block that temporally neighbors the plurality of blocks. The list of candidate motion vector predictors for a second block of the plurality of blocks may include motion information for blocks that spatially neighbor the second block, if available, and include motion information for the block that temporally neighbors the plurality of blocks.

Accordingly, in some examples, the list of candidate motion vector predictors for the first block of the plurality of blocks and the second block of the plurality of blocks may be different. However, in these examples, the motion information for the temporally neighboring block is the same. In other words, video encoder 20 and video decoder 30 determine motion information for one temporally neighboring block, and include the determined motion information for the temporally neighboring block in each list of candidate motion vector predictors for each of the plurality of blocks.

In this manner, video encoder 20 and video decoder 30 may need to determine the motion information for a temporally neighboring block only once for a plurality of blocks, rather than determining the motion information for temporally neighboring blocks for each of the plurality of blocks. In some cases, determining the motion information for temporally neighboring blocks may be a complex procedure. For instance, determining the motion information for a temporally neighboring block includes locating the temporally neighboring block in a temporal picture, scaling the motion vector (MV) of the co-located block based on picture order count (POC) value distances of the reference picture and the current picture, and deriving reference picture indices. The POC value refers to the order in which the pictures are outputted or displayed (i.e., a picture with a smaller POC value is outputted or displayed earlier than a picture with a larger POC value).

In examples where scaling is needed, the inclusion of the motion information for the temporally neighboring block in the temporal picture may mean inclusion of the scaled motion information for the temporally neighboring block in the temporal picture. Alternatively, it may be possible to include the motion information for the temporally neighboring block and then subsequently scaling. In this disclosure, including the motion information for the temporally neighboring block of the temporal picture covers either of these examples.

The reference picture indices refer to indices into a reference picture list or lists. The reference picture list or lists identify reference pictures that can be used for inter-predicting blocks within the current picture.

As described above, video encoder 20 and video decoder 30 may determine the motion information for a temporally neighboring block only once for a plurality of blocks, and include the determined motion information in all lists of candidate motion vector predictors for all blocks of the plurality of blocks. For example, video encoder 20 and video decoder 30 may determine the motion vector for a temporally neighboring block only once per CU and include the determined motion information in all list of candidate motion vector predictors for all PUs within the CU. Determining the motion vector for a temporally neighboring block only once for all blocks of the plurality of blocks may reduce complexity in implementing merge/skip mode or AMVP mode.

The motion information for spatially neighboring blocks and the temporally neighboring block may include motion vector or vectors of the spatially neighboring and temporally neighboring blocks, and the reference index or indices for the motion vector or vectors. The reference index for a motion vector may be an index into one of two reference picture lists (i.e., RefPicList0 and RefPicList1). For example, if a spatially neighboring block is uni-predicted (i.e., inter-predicted with one motion vector that refers to one reference picture), the reference index for the motion vector of the spatially neighboring block may be a reference index into RefPicList0 or RefPicList1 that identifies the reference picture used for inter-prediction. If a spatially neighboring block is bi-predicted (i.e., inter-predicted with two motion vectors, where each motion vector refers to a reference picture), there are two reference indices, one for each motion vector. The first reference index is an index into RefPicList0 and the second reference index is an index into RefPicList1. In the examples described in this disclosure, refIdx0 refers to an index into RefPicList0 and refIdx1 refers to an index into RefPicList1.

In merge mode and AMVP mode, video encoder 20 and video decoder 30 may each select motion information from the list of candidate motion vector predictors. Video encoder 20 and video decoder 30 may utilize the motion vector or vectors of the selected motion information as predictors to determine the motion vector or vectors of the current block (i.e., the block being inter-predicted). For example, if video encoder 20 and video decoder 30 selected the motion information of a spatially neighboring block from the list of candidate motion vector predictors, video encoder 20 and video decoder 30 may utilize the motion vector or vectors of the spatially neighboring block to determine the motion vector or vectors for the current block. Similarly, if video encoder 20 and video decoder 30 selected the motion information of the temporally neighboring block from the list of candidate motion vector predictors, video encoder 20 and video decoder 30 may utilize the motion vector or vectors of the temporally neighboring block to determine the motion vector or vectors for the current block.

In this sense, the motion vector or vectors of the selected motion information may form as motion vector predictors for the motion vector or vectors of the current block. As used in this disclosure, a motion vector of a spatially neighboring block, if available, may be referred to as a spatial motion vector predictor (SMVP). A motion vector of a temporally neighboring block may be referred to as a temporal motion vector predictor (TMVP). For example, if the motion information for a spatially neighboring block indicates that the spatially neighboring block is uni-predicted, then there is one SMVP. As another example, if the motion information for a temporally neighboring block indicates that the temporally neighboring block is bi-predicted, then there are two TMVPs.

In some examples, whether the temporally neighboring block is uni-predicted or bi-predicted can be decided according to the slice type. For example, for P-slice TMVP is always uni-directional (i.e., the temporally neighboring block is uni-predicted), and for B-slice TMVP can be always bi-directional. In some examples, bi-directional TMVP can be derived even if temporally neighboring block has only uni-directional motion vector. In this case, co-located motion vector is scaled according to the temporal distance for reference list L0 and reference list L1.

As described above, video encoder 20 and video decoder 30 may determine the motion information only once for a temporally neighboring block. There are various examples of the location of a temporally neighboring block. The temporally neighboring block is located in a temporally neighboring picture (i.e., a picture other than the current picture within a sequence of pictures). The temporally neighboring picture may be referred to as a temporal picture. Video encoder 20 may signal in the coded bitstream and video decoder 30 may receive from the coded bitstream the identifier for the temporal picture (e.g., the POC value of the temporal picture).

Video encoder 20 and video decoder 30 may each locate a block in the temporal picture that is located at the bottom-right of where the plurality of blocks would be located in the temporal picture. For example, assume that the plurality of blocks comprise a 16×16 CU in the current picture. In this example, assume that the top-left corner of the CU is located at (16, 16) within the current picture, and the bottom-right corner of the CU is located at (31, 31) within the current picture. In this case, video encoder 20 and video decoder 30 may locate a block that is located to the bottom-right of the CU, but in the temporal picture. For instance, the block located to bottom-right of the CU in the temporal picture may be a 4×4 block whose top-left corner is located at (32, 32) in the temporal picture and bottom-right corner is located at (35, 35).

Video encoder 20 and video decoder 30 may determine whether this bottom-right block is inter-predicted. If the bottom-right block is inter-predicted, video encoder 20 and video decoder 30 may include the motion information for this bottom-right block in the list of candidate motion vector predictors for each of the blocks of the plurality of blocks (i.e., each PU within the CU). For example, if the bottom-right block is un-predicted, video encoder 20 and video decoder 30 may include one TMVP in the list of candidate motion vector predictors for all PUs within the CU. If the bottom-right block is bi-predicted, video encoder 20 and video decoder 30 may include two TMVPs in the list of candidate motion vector predictors for all PUs within the CU.

If, however, the bottom-right block is not inter-predicted, video encoder 20 and video decoder 30 may evaluate the motion information for another block in the temporal picture. This block may be located in the center of the arrangement of the plurality of blocks, and extending towards the bottom and to the right. For example, assume that the plurality of blocks forms a 64×64 LCU, whose top-left corner is located at (64, 64) and bottom-right corner is located at (127, 127). In this example, the center of the LCU can be defined at (96, 96). Video encoder 20 and video decoder 30 may determine the location (96, 96) in the temporal picture and determine the 4×4 block that extends towards the right and towards the bottom in the temporal picture. In this example, the 4×4 block in the temporal picture is the block whose top-left corner is located at (96, 96) and whose bottom-right corner is located at (99, 99).

Video encoder 20 and video decoder 30 may determine whether this center-bottom-right block in the temporal picture is inter-predicted. Similar to above, if the center-bottom-right block is inter-predicted, video encoder 20 and video decoder 30 may include the motion information of the center-bottom-right block in the list of candidate motion vector predictors for each of the blocks of the plurality of blocks (i.e., each CU in the LCU, in this example). If neither the bottom-right block nor the center-bottom-right block in the temporal picture is inter-predicted, video encoder 20 and video decoder 30 may determine that no motion information for a temporally neighboring block should be included in the list of candidate motion vector predictors for the blocks of the plurality of blocks.

It should be understood that the location of the temporally neighboring block for the plurality of blocks being the bottom-right block in the temporal picture of the center-bottom-right block in the temporal picture are described for purposes of illustration only, and should not be considered limiting. In some examples, the location of the temporally neighboring block may be different than the bottom-right block and/or the center-bottom-right block. Moreover, if neither the bottom-right block nor the center-bottom-right block is inter-predicted, it may be possible for video encoder 20 and video decoder 30 to evaluate the motion information for other blocks within the temporal picture.

In some examples, the location of the temporally neighboring block that temporally neighbors the plurality of blocks may be fixed. For example, for the plurality of blocks, video encoder 20 and video decoder 30 may determine the motion information for the bottom-right block in the temporal picture, followed by the motion information for the center-bottom-right block in the temporal picture. In these examples, the location of the temporally neighboring block may be fixed regardless of the manner in which the CU or LCU is partitioned (i.e., regardless of the partition mode of the CU or LCU). For instance, regardless of whether a 2N×2N CU is partitioned into two 2N×N PUs, two N×2N PUs, or four N×N PUs, the location of the block that temporally neighbors the CU may be fixed (i.e., first evaluate the block to the bottom-right in the temporal picture, followed by the block at the center-bottom-right in the temporal picture). The same may apply if the CU is asymmetrically partitioned.

In some examples, the location of the temporally neighboring block that temporally neighbors the plurality of blocks may be based on the arrangement of the plurality of blocks. In these examples, the location of the temporally neighboring block may be based on the manner in which the CU or LCU is partitioned (i.e., the arrangement of the plurality of blocks). For example, if the CU is 2N×2N, and the CU is partitioned into two 2N×N PUs, the location of the temporally neighboring block that temporally neighbors the CU may be at a first location. If the CU is partitioned into two N×2N PUs, the location of the temporally neighboring block that temporally neighbors the CU may be in a second location. If the CU is partitioned into four N×N PUs, the location of the temporally neighboring block that temporally neighbors the CU may be in a third location. The same may apply if the CU is asymmetrically partitioned.

In either case (e.g., where location of temporally neighboring block is fixed or based on the partition mode), video encoder 20 and video decoder 30 may determine the motion information for the block that temporally neighbors the plurality of blocks only once. Video encoder 20 and video decoder 30 may not determine the motion vector for temporally neighboring blocks for each block of the plurality of blocks.

In some examples, video encoder 20 may signal in the coded bitstream and video decoder 30 may receive from the coded bitstream information that indicates the size of plurality of blocks for which video encoder 20 and video decoder 30 determine the motion information for the temporally neighboring block. For instance, video encoder 20 may signal, in the coded bitstream that video decoder 30 directly receives or receives through a storage medium, whether video decoder 30 should determine the motion information for a temporally neighboring block that temporally neighbors a CU, an LCU, or some other grouping of the plurality of blocks. Video encoder 20 may signal and video decoder 30 may receive such information in the picture parameter set (PPS), sequence parameter set (SPS), the picture header, the slice header, or within the CU or LCU, as a few examples.

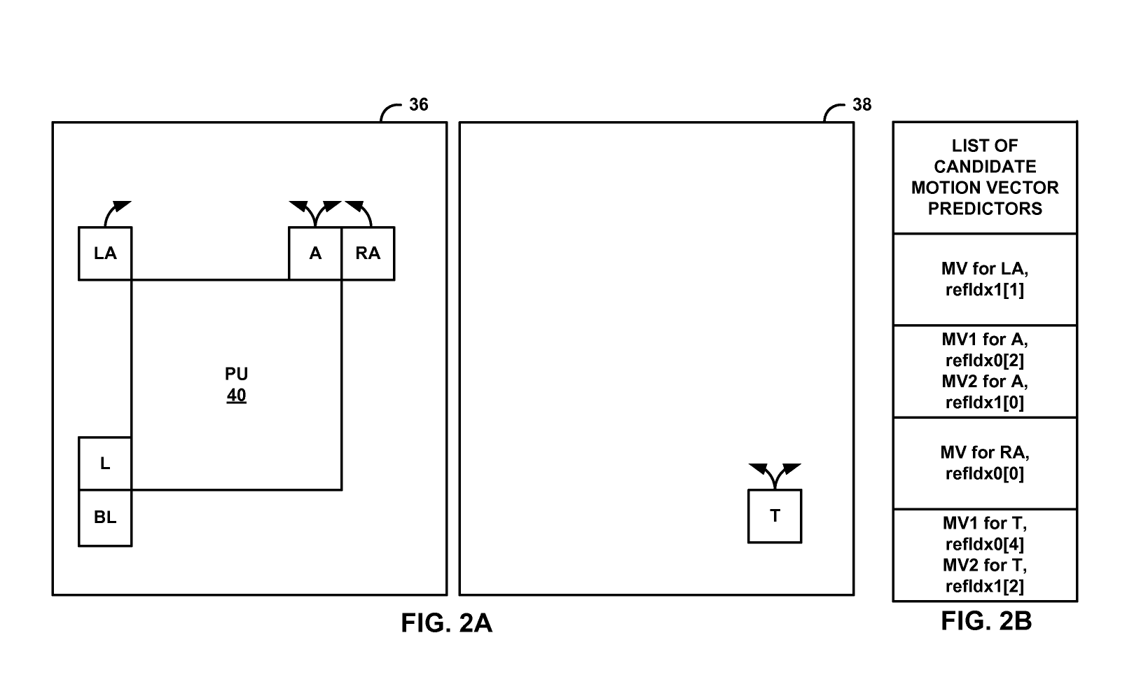

FIG. 2A is a block diagram illustrating an example of a block that is to be predicted and spatially and temporally neighboring blocks of the block that is to be predicted. FIG. 2B is a conceptual diagram illustrating an example of a list of candidate motion vector predictors for the block of FIG. 2A that is to be predicted. For example, FIG. 2A illustrates picture 36 that includes PU 40. In FIG. 2A, five blocks that spatially neighbor PU 40 are illustrated. The five spatially neighboring blocks are BL, L, LA, A, and RA. These spatially neighboring blocks are illustrated for example purposes only, and there may be more, fewer, or different spatially neighboring blocks than those illustrated in FIG. 2A. In general, the location of the spatially neighboring blocks whose motion information may be included in the list of candidate motion vector predictors may be the same as defined in the HEVC standard.

FIG. 2B illustrates the list of candidate motion vector predictors for PU 40. It should be understood that video encoder 20 constructs a list of candidate motion vector predictors that video encoder 20 uses for encoding PU 40. Video decoder 30 also constructs a list of candidate motion vector predictors that video decoder 30 uses for decoding PU 40. However, the list of candidate motion vector predictors that video encoder 20 constructs and the list of candidate motion vector predictors that video decoder 30 constructs may be substantially the same list. Accordingly, FIG. 2B illustrates the list of candidate motion vector predictors that video encoder 20 constructs, and illustrates the list of candidate motion vector predictors that video decoder 30 constructs.

In FIGS. 2A and 2B, video encoder 20 and video decoder 30 may determine the motion information for spatially neighboring blocks BL, L, LA, A, and RA, and may include the motion information, if available, for the spatially neighboring blocks that are inter-predicted. In FIG. 2A, spatially neighboring blocks BL and L are intra-predicted, and therefore there is no motion information for these two spatially neighboring blocks.

In other words, motion information for blocks BL and L is not available. However, motion information for blocks LA, A, and RA is available, in this example. Accordingly, video encoder 20 and video decoder may include the motion information that is available for the spatially neighboring blocks (e.g., blocks LA, A, and RA) as described below.

In FIG. 2A, block LA is inter-predicted with one motion vector that refers to a picture identified in RefPicList1, as illustrated by the arrow pointing to the right from block LA. In this example, video encoder 20 and video decoder 30 may include the motion information of LA in the list of candidate motion vector predictors for PU 40. For instance, FIG. 2B illustrates that the first entry in the list of candidate motion vector predictors for PU 40 is the motion vector (MV) of block LA, and the reference index into RefPicList1 is identified as refIdx1[1], which means that block LA is inter-predicted with respect to the second reference picture identified in RefPicList1 (assuming that the reference index for first reference picture identified in RefPicList1 is 0). In this example, the motion vector for block LA is a spatial temporal motion vector predictor (SMVP) for determining the motion vector of PU 40.

Block A is inter-predicted with two motion vectors, as illustrated by the two arrows pointing to the left and to the right, respectively, from block A. Video encoder 20 and video decoder 30 may include the motion information for block A in the list of candidate motion vector predictors for PU 40. For example, as illustrated in FIG. 2B, the second entry in the list of candidate motion vector predictors includes the first motion vector for block A and the reference index for the first motion vector for block A into RefPicList0 (i.e., refIdx0[2]). The second entry in the list of candidate motion vector predictors also includes the second motion vector for block A and the reference index for the second motion vector for block A into RefPicList1 (i.e., refIdx1[0]). In this example, the motion vectors for block A are SMVPs for determining the motion vector of PU 40.

Block RA is inter-predicted with one motion vector, as illustrated by the arrow pointing to the left from block RA. Similar to above, video encoder 20 and video decoder 30 may include the motion information for block RA in the list of candidate motion vector predictors for PU 40. For instance, the third entry in the list of candidate motion vector predictors for PU 40 includes the motion vector for block RA and the reference index for the motion vector of block RA into RefPicList0 (i.e., refIdx0[0]).

FIG. 2A also illustrates picture 38. Picture 38 is a temporal picture that video encoder 20 indicated in the coded bitstream as being the picture from which video encoder 20 and video decoder 30 are to determine the temporally neighboring block. For example, video encoder 20 may signal in the coded bitstream and video decoder 30 may receive from the coded bitstream the POC value for picture 38 to determine the temporal picture that is to be used for determining the temporally neighboring block.

In this example, assume that video encoder 20 and video decoder 30 identified block T of picture 38 as the temporally neighboring block. For example, although FIG. 2A illustrates PU 40, PU 40 may be one of a plurality of PUs for a CU. In this example, block T of picture 38 may be a block that temporally neighbors the CU that includes PU 40.

As illustrated, block T is inter-predicted with respect to two motion vectors. In this example, video encoder 20 and video decoder 30 may scale the two motion vectors of block T based on the POC value of picture 38, the POC value of picture 36, and the POC values of the pictures to which the two motion vectors of block T refer. As illustrated in FIG. 2B, video encoder 20 and video decoder 30 include the scaled motion vectors as the fourth entry in the list of candidate motion vector predictors for PU 40. In this example, the two motion vectors of block T are each an example of a temporal motion vector predictor (TMVP) for the motion vectors of PU 40. For example, there are two TMVPs from block T.

In some examples, video encoder 20 and video decoder 30 may not include the actual reference index or indices of block T in the list of candidate motion vector predictors. For instance, FIG. 2B illustrates the reference index for the first scaled motion vector of block T as being refIdx0[4], and the reference index for the second scaled motion vector of block T as being refIdx1[2]. However, refIdx0[4] and refIdx1[2] may not be the actual reference indices for the motion vectors of block T. As described in more detail below, video encoder 20 and video decoder 30 may derive the reference indices for the scaled motion vectors of block T, and the result of this derivation may be that one reference index is refIdx0[4] and the other reference index is refIdx1[2].

In this example, if video encoder 20 and video decoder 30 utilize the motion vectors of block T (i.e., the two TMVPs) to determine the motion vectors of PU 40, video encoder 20 and video decoder 30 may not use the reference indices of the two TMVPs to determine the reference indices of the motion vectors of PU 40. Rather, video encoder 20 and video decoder 30 may derive the reference indices for the two motion vectors of PU 40.

In accordance with the techniques described in this disclosure, video encoder 20 and video decoder 30 may determine the motion information for block T once, and include the motion information in the list of motion vector predictors for each PU in the CU. For example, as described above, PU 40 may be one PU of a plurality of PUs within the CU. Video encoder 20 and video decoder 30 may construct a list of candidate motion vector predictors for each of the PUs within the CU.

In this example, for a PU, other than PU 40, in the CU, video encoder 20 and video decoder 30 may implement similar techniques as described above with respect to PU 40. In some examples, the SMVPs for this other PU in the CU may be different than the SMVPs for PU 40. For example, at least one of the first three entries in the list of candidate motion vector predictors for PU 40 may not be an entry in the list of candidate motion vector predictors for the other PU in the CU. However, the TMVP entry in the list of candidate motion vector predictors for this other PU in the CU will be the same as the TMVP entry in the list of candidate motion vector predictors for PU 40.

For example, the SMVPs for a PU in a CU may be referred to as SMVP candidates, and the TMVP for a PU in a CU may be referred to as a TMVP candidate. In accordance with the techniques described in this disclosure, the SMVP candidates for different PUs within a CU may be different, but the TMVP candidate for the different PUs within the CU is the same.

Furthermore, the list of candidate motion vector predictors need not necessarily include the reference index or indices for the SMVPs in every example. For example, in merge mode and AMVP mode, video encoder 20 signals in the coded bitstream and video decoder 30 receives from the coded bitstream an index into the candidate list of motion vector predictors. In merge mode, video decoder 30 selects the motion information from the signaled index into the candidate list of motion vector predictors, and sets the motion vector or vectors of the selected motion information as the motion vector or vectors for PU 40. If the selected motion information is for a spatially neighboring block, then video decoder 30 sets the reference index or indices as the reference index or indices of the motion vector or vectors of PU 40. If the selected motion information is for the temporally neighboring block, then video decoder 30 derives the reference index or indices, as described in more detail below.

In some examples, it may be possible for video encoder 20 and video decoder 30 to derive the reference index or indices for the temporally neighboring block in AMVP mode. However, for purposes of illustration, the derivation techniques of the reference index or indices for the temporally neighboring block are described with respect to the merge mode.

As an illustrative example, in merge mode, assume that video encoder 20 signaled, in the coded bitstream, the index value of two into the list of candidate motion vector predictors for PU 40. In this example, assuming that index value for the first entry in list of candidate motion vector predictors is zero, video decoder 30 may select the motion information for block RA (i.e., the third entry in the list of candidate motion vector predictors). Video decoder 30 may set the motion vector of block RA as the motion vector of PU 40. Video decoder 30 may also set the reference index to refIdx0[0], meaning that video decoder 30 will utilize the reference picture in RefPicList0 identified by refIdx0[0] (i.e., the first reference picture identified in RefPicList0) to inter-predict PU 40. The motion vector of PU 40 may indicate the block in the first reference picture identified in RefPicList0 that video decoder 30 is to use to inter-predict PU 40.

In AMVP mode, video encoder 20 may signal, in the coded bitstream, an index into the list of candidate motion vector predictors, and may additionally signal a motion vector difference (MVD) between the actual motion vector of PU 40 and the motion vector of the motion information identified by the index into the list of candidate motion vector predictors. For instance, as above, assume that video decoder 30 selected the motion information of block RA based on the signaled index value into the list of candidate motion vector predictors. In this example, video decoder 30 may add or subtract the signaled MVD with the motion vector of block RA to determine the motion vector of PU 40.

Also, in some examples, in AMVP mode, video encoder 20 may signal the reference index into the reference picture list that video decoder 30 is to utilize for inter-predicting PU 40. For instance, video decoder 30 may not utilize the reference index of block RA to determine the reference picture that video decoder 30 is to use for inter-predicting PU 40. Rather, video decoder 30 may utilize the signaled reference index into the reference picture to determine the reference picture that video decoder 30 is to use for inter-predicting PU 40. In AMVP mode, video encoder 20 and video decoder 30 may not need to include the reference index or indices of the SMVP candidates or the TMVP candidate in the list of candidate motion vector predictors because video encoder 20 signals the reference index into the reference picture list that video decoder 30 is to use for inter-predicting PU 40 when the selected motion information is for the SMVP candidate or the TMVP candidate.

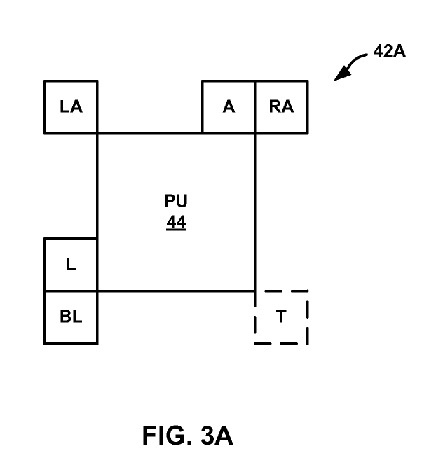

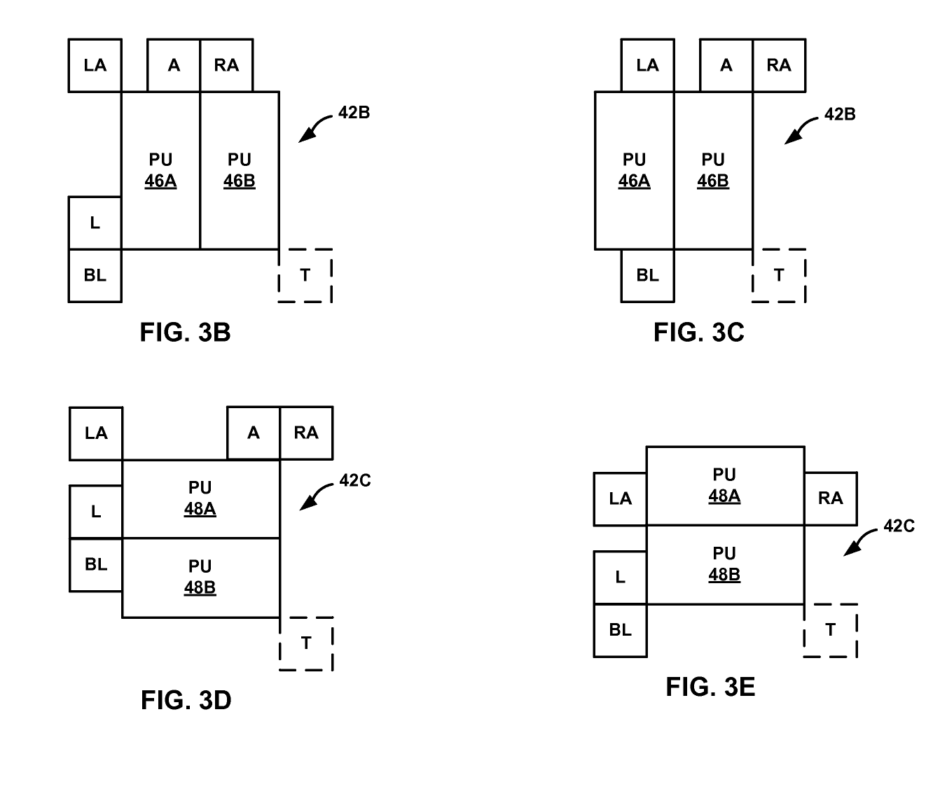

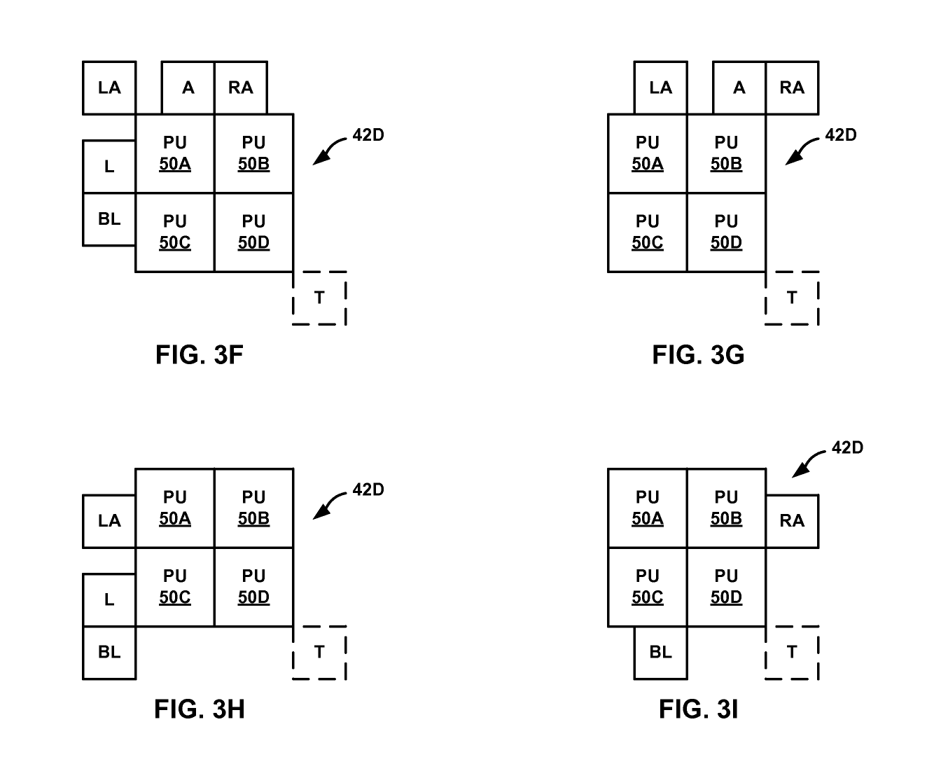

FIGS. 3A-3I are conceptual diagrams illustrating a location of a temporally neighboring block that is fixed. In FIGS. 3A-3I, the temporally neighboring block is identified as block T, and is illustrated in a dashed box. Block T is illustrated in a dashed box to indicate that block T does not reside in the same picture as the picture that includes the CUs of FIGS. 3A-3I. Rather, block T resides within a temporal picture that is different than the picture that includes the CUs of FIGS. 3A-3I. Also, in FIGS. 3A-3I, the location of block T is illustrated as being in the bottom-right of where the CUs of FIGS. 3A-3I would be located in the temporal picture.

However, this location of block T is one example. In some examples, the location of block T may be different than the bottom-right block in the temporal picture. Also, if block T is not inter-predicted, video encoder 20 and video decoder 30 may determine whether one or more other temporally neighboring blocks are inter-predicted. As one example, video encoder 20 and video decoder 30 may determine whether the center-bottom-right block in the temporal picture is inter-predicted if block T is not inter-predicted. In general, the location of the temporally neighboring block may be within the region that the CU encompasses if the CU were within the temporal picture, or external to the region that the CU encompasses if the CU were within the temporal picture.

For example, FIG. 3A illustrates another exemplary CU 42A that includes PU 44. In this example, PU 44 is the same size as CU 42A meaning that CU 42A is not further partitioned into a plurality of PUs. In this example, video encoder 20 and video decoder 30 may determine whether the five illustrated spatially neighboring blocks (i.e., blocks BL, L, LA, A, and RA) are inter-predicted, and include the motion vectors of the inter-predicted blocks as the SMVPs in the list of candidate motion vector predictors for PU 44. Video encoder 20 and video decoder 30 may determine the motion vector or vectors of temporally neighboring block T, and include the motion vector or vectors as TMVP or TMVPs in the list of candidate motion vector predictors for PU 44.

FIGS. 3B and 3C illustrate an exemplary CU 42B. In FIGS. 3B and 3C, CU 42B is partitioned into two PUs (i.e., PU 46A and PU 46B). For instance, if CU 42B is a 2N×2N CU, then, in FIGS. 3B and 3C, CU 42B is partitioned into two N×2N PUs. In FIG. 3B, video encoder 20 and video decoder 30 may construct the list of candidate motion vector predictors for PU 46A. In FIG. 3C, video encoder 20 and video decoder 30 may construct the list of candidate motion vector predictors for PU 46B.

As illustrated, the spatially neighboring blocks for PU 46A are different than the spatially neighboring blocks for PU 46B. Accordingly, the SMVP candidates in the list of candidate motion vector predictors for PU 46A are different than the SMVP candidates in the list of candidate motion vector predictors for PU 46B. However, in FIGS. 3B and 3C, the TMVP candidate is the same for PU 46A and PU 46B. Accordingly, in this example, video encoder 20 and video decoder 30 may determine the motion information for the temporally neighboring block T once, and include the motion information for the temporally neighboring block T in the list of candidate motion vector predictors for both PU 46A and PU 46B. Video encoder 20 and video decoder 30 may not need to determine the motion information for the individual blocks that temporally neighboring PU 46A and PU 46B.

FIGS. 3D and 3E illustrate another exemplary CU 42C. In FIGS. 3D and 3E, CU 42C is partitioned into two PUs (i.e., PU 48A and PU 48B). For instance, if CU 42C is a 2N×2N CU, then, in FIGS. 3D and 3E, CU 42C is partitioned into two 2N×N PUs. In FIG. 3D, video encoder 20 and video decoder 30 may construct the list of candidate motion vector predictors for PU 48A. In FIG. 3E, video encoder 20 and video decoder 30 may construct the list of candidate motion vector predictors for PU 48B.

Similar to FIGS. 3B and 3C, as illustrated in FIGS. 3D and 3E, the spatially neighboring blocks for PU 48A are different than the spatially neighboring blocks for PU 48B. In this example, video encoder 20 and video decoder 30 may determine the SMVPs candidates for both PU 48A and PU 48B individually. However, in FIGS. 3D and 3E, the TMVP candidate is the same for PU 48A and PU 48B. Accordingly, in this example, video encoder 20 and video decoder 30 may determine the motion information for the temporally neighboring block T once, and include the motion information for the temporally neighboring block T in the list of candidate motion vector predictors for both PU 48A and PU 48B. Similar to FIGS. 3B and 3C, video encoder 20 and video decoder 30 may not need to determine the motion information for the individual blocks that temporally neighboring PU 48A and PU 48B.

FIGS. 3F-3I illustrate another exemplary CU 42D. In FIGS. 3F-3I, CU 42D is partitioned into four PUs (i.e., PU 50A, PU 50B, PU 50C and PU 50D). For instance, if CU 42D is a 2N×2N CU, then, in FIGS. 3F-3I, CU 42D is partitioned into four N×N PUs. In FIG. 3F, video encoder 20 and video decoder 30 may construct the list of candidate motion vector predictors for PU 50A. In FIG. 3G, video encoder 20 and video decoder 30 may construct the list of candidate motion vector predictors for PU 50B. In FIG. 3H, video encoder 20 and video decoder 30 may construct the list of candidate motion vector predictors for PU 50C. In FIG. 3I, video encoder 20 and video decoder 30 may construct the list of candidate motion vector predictors for PU 50D.

In FIGS. 3F-3I, the spatially neighboring blocks for PU 50A, PU 50B, PU 50C, and PU 50D are different. Accordingly, the SMVPs in the respective list of candidate motion vector predictors for PU 50A, PU 50B, PU 50C, and PU 50D are different. However, for determining the TMVP candidate for the respective list of candidate motion vector predictors for PU 50A, PU 50B, PU 50C, and PU 50D, video encoder 20 and video decoder 30 may determine the motion information for temporally neighboring block T only once, rather than determining the motion information for each temporally neighboring block of PU 50A, PU 50B, PU 50C, and PU 50D individually.

In this manner, video encoder 20 and video decoder 30 may reduce the complexity of determining the TMVP candidates for the list of candidate motion vector predictors for blocks within the plurality of blocks. For instance, rather than determining the TMVP candidate on a block-by-block basis for the blocks of the plurality of blocks, video encoder 20 and video decoder 30 may determine a common TMVP candidate for all blocks of the plurality of blocks, and include this common TMVP candidate in the list of candidate motion vector predictors for all of the blocks of the plurality of blocks even if the SMVP candidates in the list of candidate motion vector predictors for the blocks of the plurality of blocks is different.

In the examples illustrated in FIGS. 3A-3I, the location of temporally neighboring block T was fixed regardless of the arrangement of the plurality of blocks. For example, temporally neighboring T was fixed to the bottom-right block in the temporal picture regardless of whether the CU was partitioned into one PU, two 2N×N PUs, two N×2N PUs, or four N×N PUs (i.e., regardless of the partition mode of the CU). However, the techniques described in this disclosure are not so limited.

In some examples, the location of the temporally neighboring block in the temporal picture may be based on the arrangement of the plurality of blocks. For example, the location of the temporally neighboring block may be fixed for all blocks of the plurality of blocks, but the location of the temporally neighboring block may be based on the arrangement of the plurality of blocks. In some examples, the arrangement of the plurality of blocks refers to the manner in which the CU, LCU, or any other sized block is partitioned (i.e., the partition mode).

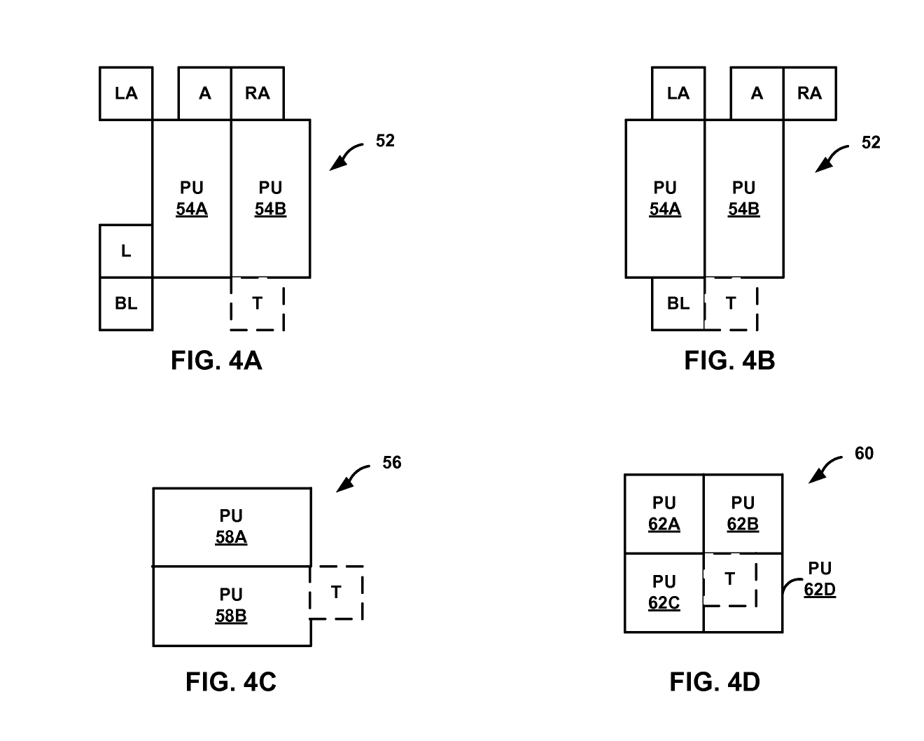

FIGS. 4A-4D are conceptual diagrams illustrating a location of a temporally neighboring block that is based on the arrangement of the plurality of blocks. Similar to FIGS. 3A-3I, in FIGS. 4A-4D, the temporally neighboring block is identified as block T, and is illustrated in a dashed box to indicate that block T does not reside in the same picture as the picture that includes the CUs of FIGS. 4A-4D. Also, in the examples of FIGS. 4A-4D, if CUs were not partitioned, then the location of the temporally neighboring block may be same as the location of the temporally neighboring block illustrated in FIG. 3A. However, the location of the temporally neighboring block in FIGS. 4A-4D may be different for different partitions of the CU.

FIGS. 4A and 4B illustrate exemplary CU 52 that is partitioned into two N×2N PUs 54A and 54B. FIG. 4A illustrates the spatially neighboring blocks of PU 54A, and FIG. 4B illustrates the spatially neighboring blocks of PU 54B. In the examples of FIGS. 4A and 4B, the temporally neighboring block T is located at the bottom-right of where PU 54A would be located in the temporal picture. As illustrated, the location of temporally neighboring block T in FIGS. 4A and 4B is different than the location of temporally neighboring block T in FIGS. 3A-3I due to the manner in which CU 52 is partitioned.

FIGS. 4C and 4D illustrate exemplary CU 56 and CU 60, respectively. In FIGS. 4C and 4D, the spatially neighboring blocks are not illustrated for ease of illustration purposes. In FIG. 4C, CU 56 is partitioned into two 2N×N PUs 58A and 58B. In this partition (i.e., the arrangement of PU 58A and PU 58B), the location of the temporally neighboring block T is the bottom-right block of where PU 58A would be located in the temporal picture. In FIG. 4D, CU 60 is partitioned into four N×N PUs 62A, 62B, 62C, and 62D. In this partition (i.e., arrangement of PU 62A, PU 62B, PU 62C, and PU 62D), the location of temporally neighboring block T is the bottom-right block of where PU 62A would be located in the temporal picture.

In this manner, in some examples, the location of the temporally neighboring block may be based on the partition mode of the CU or LCU. If the CU is partitioned in a first partition mode (e.g., as illustrated in FIG. 3A), then the temporally neighboring block may be located at a first location in the temporal picture. If the CU is partitioned in a second partition mode (e.g., as illustrated in FIGS. 4A and 4B), then the temporally neighboring block may be located at a second location in the temporal picture. If the CU is partitioned in a third partition mode (e.g., as illustrated in FIG. 4C), then the temporally neighboring block may be located at a third location in the temporal picture. If the CU is partitioned in a fourth partition mode (e.g., as illustrated in FIG. 4D), then the temporally neighboring block may be located at a fourth location in the temporal picture.

The first, second, third, and fourth locations may each be different locations in the temporal picture. Alternatively, two or more of the first, second, third, and fourth locations may be the same location in the temporal picture. The location of the temporally neighboring block may be different than illustrated in FIGS. 4A-4D. Also, if the temporally neighboring block in FIGS. 4A-4D is not inter-predicted, then video encoder 20 and video decoder 30 may evaluate the motion information for another temporally neighboring block to determine whether this other temporally neighboring block is inter-predicted. The location of this other temporally neighboring block may also be a function of the partition mode of the CU or LCU.

As described above, in merge/skip mode, if the index into the list of candidate motion vector predictors identifies motion information for a spatially neighboring block, video encoder 20 and video decoder 30 select the motion information of a spatially neighboring block to determine the motion vector or vectors of the current block. For example, video encoder 20 and video decoder 30 set the motion vector or vectors of the spatially neighboring block (i.e., the SMVP or the SMVPs) as the motion vector or motion vectors of the current block. Video encoder 20 and video decoder 30 also set the reference index or indices of the SMVP or SMVPs as the reference index or indices of the motion vector or vectors of the current block.

In merge/skip mode, if the index into the list of candidate motion vector predictors identifies motion information for the temporally neighboring block (i.e., the block that temporally neighbors the plurality of blocks), video encoder 20 and video decoder 30 select the motion information of the temporally neighboring block to determine the motion vector or vectors of the current block. For instance, similar to the example of the spatially neighboring block, video encoder 20 and video decoder 30 set the scaled motion vector or vectors of the temporally neighboring block (i.e., the TMVP or TMVPs) as the motion vector or motion vectors of the current block. However, different from the example of the spatially neighboring block, video encoder 20 and video decoder 30 may not set the reference index or indices of the TMVP or TMVPs as the reference index or indices of the motion vector or vectors of the current block. Rather, video encoder 20 and video decoder 30 may derive the reference index or indices of the motion vector or vectors of the current block.

Video encoder 20 and video decoder 30 may derive the reference index or indices of the current block rather than setting them equal to the reference index or indices of the TMVP or TMVPs because the TMVP or TMVPs may refer to reference picture list(s) that are different than the reference picture list(s) of the current block. For example, when inter-predicting the blocks in the temporal picture, which is the picture that includes the temporally neighboring block, video encoder 20 and video decoder 30 constructed first and second reference picture lists for the temporal picture. When inter-predicting the blocks in the current picture, which is the picture that includes the current block to be inter-predicted, video encoder 20 and video decoder 30 constructed first and second reference picture lists for the current picture. However, the first and second reference picture lists for the temporal picture and the first and second reference picture lists for the current picture may be different reference picture lists.

Also, when inter-predicting the temporally neighboring block, the reference index or indices for the motion vector or vectors for the temporally neighboring block referred to a reference picture in the first and/or second reference picture lists of the temporal picture that was the best suited for inter-predicting the temporally neighboring block. Because the first and second reference picture lists for the temporal picture may be different than the first and second reference picture lists for the current picture, the reference index or indices of the temporally neighboring block may not necessarily refer to reference pictures in the first and second reference picture lists of the current picture that provide suitable inter-prediction efficiency.

For instance, the first and second reference picture lists that include reference pictures to inter-predict a spatially neighboring block is the same first and second reference picture lists that are to be used for identifying reference pictures to inter-predict the current block. In this manner, the reference index or indices of the motion vector or vectors of the spatially neighboring block may be a reasonable approximation as the actual reference index or indices of the motion vector or vectors of the current block. However, the reference index or indices of the motion vector or vectors of the temporally neighboring block may not be a reasonable approximation as the actual reference index or indices of the motion vector or vectors of the current block.

Accordingly, in some examples, video encoder 20 and video decoder 30 may derive the reference index or indices of the TMVP or TMVPs. It should be understood that deriving the reference index or indices of the TMVP or TMVPs may not be necessary in every example, and video encoder 20 and video decoder 30 may set the reference index or indices of the motion vector or vectors of the current block equal to the reference index or indices of the motion vector or vectors of the temporally neighboring block.

There may be various ways in which video encoder 20 and video decoder 30 derive the reference index or indices of the TMVP or TMVPs. As one example, video encoder 20 and video decoder 30 may simply set the reference index or indices of the TMVP or TMPVs equal to zero in each of the first and second reference picture lists. For instance, if the temporally neighboring block is uni-predicted, there is one TMVP, and video encoder 20 and video decoder 30 may set the reference index of the TMVP equal to refIdx0[0] or refIdx1[0]. If the temporally neighboring block is bi-predicted, there are two TMVPs, and video encoder 20 and video decoder 30 may set the reference index of the first TMVP equal to refIdx0[0] and set the reference index of the second TMVP equal to refIdx1[0].

In some examples, rather than setting the reference index or indices of the TMVP or TMVPs equal to zero in each of the reference picture lists, video encoder 20 and video decoder 30 may determine the reference index or indices of a motion vector or vectors of a spatially neighboring block. In these examples, video encoder 20 and video decoder 30 may set the reference index or indices of the motion vector or vectors of the spatially neighboring block equal to the reference index or indices of the motion vector or vectors of the current block.

For instance, in these examples, the current block is the block being inter-predicted, and in these examples, the TMVP or TMVPs form the motion vector or vectors of the current block. However, the reference index for the TMVP and TMVPs may be unknown, and may be derived from the motion vector or vectors of a spatially neighboring block.

The spatially neighboring block whose reference index or indices is used to determine the reference index or indices of the motion vector or vectors of the current block need not necessarily be a spatially neighboring block whose motion information video encoder 20 and video decoder 30 includes the list of candidate motion vector predictors. Again, the motion vector or vectors of the current block, in these examples, are the TMVP or TMPVs. However, it may be possible that video encoder 20 and video decoder 30 include the motion information for the spatially neighboring block in the list of candidate motion vector predictors. It should be understood that the spatially neighboring block, in this case, is not used to determine the motion vector or vectors of the current block, but rather the reference index or indices for the motion vector or vectors of the current block.

One example of the spatially neighboring block whose reference index or indices is used may be the block located to the left of the plurality of blocks (e.g., the PU located to the left of the CU). The block located to the left is one example, and there may be other examples of blocks whose reference index or indices video encoder 20 and video decoder 30 use for determining the reference index or indices for the motion vector or vectors of the current block.

If the spatially neighboring block is not inter-predicted, then video encoder 20 and video decoder 30 may determine whether one or more other spatially neighboring blocks are inter-predicted and utilize the reference index or indices of the spatially neighboring block as the reference index or indices of the motion vector or vectors of the current block. In some examples, if the spatially neighboring block is not inter-predicted, video encoder 20 and video decoder 30 may set the reference index or indices of the motion vector or vectors of the current block equal to zero (i.e., the reference index for the motion vector is refIdx0[0] or refIdx1[0], or the reference indices for the motion vectors are refIdx0[0] and refIdx1[0]).

As one example, assume that the temporally neighboring block is uni-predicted (i.e., inter-predicted with one motion vector). In this example, there is one TMVP because the temporally neighboring block is uni-predicted. Video encoder 20 and video decoder 30 may determine whether the spatially neighboring block is inter-predicted with respect to a first reference picture list (RefPicList0) and/or a second reference picture list (RefPicList1). Video encoder 20 and video decoder 30 may also determine the reference index or indices into RefPicList0 and/or RefPicList1 (i.e., refIdx0[X] and refIdx1[Y]). In this example, if the spatially neighboring block is uni-predicted with respect to RefPicList0, and the reference index into RefPicList0 is refIdx0[X], video encoder 20 and video decoder 30 may set the reference index to refIdx0[X] for the current block, and utilize the picture identified by refIdx0[X] in RefPicList0 as a reference picture to inter-predict the current block. If the spatially neighboring block is uni-predicted with respect to RefPicList1, and the reference index into RefPicList1 is refIdx1[Y], video encoder 20 and video decoder 30 may set the reference index to refIdx1[Y] for the current block, and utilize the picture identified by refIdx1[Y] in RefPicList1 as a reference picture to inter-predict the current block. In either case, the TMVP may identify the block in the reference picture that is to be used to inter-predict the current block.

As another example, assume that the temporally neighboring block is bi-predicted (i.e., inter-predicted with two motion vectors). In this example, each of the two motion vectors forms a TMVP. In other words, in this example, there are two TMVPs because the temporally neighboring block is bi-predicted. Also, assume that the spatially neighboring block is bi-predicted with two motion vectors. For the bi-predicted spatially neighboring block, assume that the first motion vector refers to a picture in RefPicList0 identified by refIdx0[X], and the second motion vector refers to a picture in RefPicList1 identified by refIdx1[Y]. In this example, video encoder 20 and video decoder 30 may set refIdx0[X] into RefPicList0 as the reference index for the first TMVP, and set refIdx1[Y] into RefPicList1 as the reference index for the second TMVP. For example, the first TMVP may identify the block in the first reference picture, where refIdx0[X] in RefPicList0 identifies the first reference picture. The second TMVP may identify the block in the second reference picture, where refIdx1[Y] in RefPicList1 identifies the second reference picture.

In some cases, it may be possible that there are not sufficient reference indices in the spatially neighboring block to determine the reference indices for the current block. For example, assume that the temporally neighboring block is bi-predicted (i.e., there are two TMVPs), and the spatially neighboring block is uni-predicted (i.e., with one motion vector). In this case, video encoder 20 and video decoder 30 may determine a reference index for a reference picture list for one of the two TMVPs, but may not have sufficient reference indices to determine a reference index for a reference picture list for other one of the two TMVPs.

For instance, assume that the spatially neighboring uni-predicted block is inter-predicted with respect to a picture in RefPicList0 identified by refIdx0[X]. In this example, video encoder 20 and video decoder 30 may set the reference index for the first TMVP to refIdx0[X], which identifies a reference picture in RefPicList0. However, in this example, there is no reference index for RefPicList1 because the spatially neighboring block is only uni-predicted with respect to RefPicList0. To address this, in some examples, video encoder 20 and video decoder 30 may set the reference index into the reference picture list for which a reference index is unavailable equal to the reference index of the available reference picture list.

For example, if refIdx1[Y] is the reference index into RefPicList1, then the video coder may set refIdx1[Y] equal to refIdx0[X] (i.e., set Y equal to X). Similar to above, in this example, the first TMVP may identify the block in the first reference picture, where refIdx0[X] in RefPicList0 identifies the first reference picture. The second TMVP may identify the block in the second reference picture, where refIdx1[Y] in RefPicList1 identifies the second reference picture, and Y equals X. However, in this example, video encoder 20 and video decoder 30 determined the value of refIdx1[Y] based on the value of refIdx0[X], and not based on the spatially neighboring block.

Also, if the spatially neighboring block is uni-predicted with respect to a picture in RefPicList1 identified by refIdx1[Y], then video encoder 20 and video decoder 30 may set the value of refIdx0[X] equal to refIdx1[Y] (i.e. set X equal to Y). In other words, in this example, the reference index for RefPicList0 is unavailable, and the video coder may determine the reference index for RefPicList0 based on the reference index for RefPicList1 (i.e., sets X equal to Y). For instance, if the temporally neighboring block is bi-predicted, and the spatially neighboring block is uni-predicted, video encoder 20 and video decoder 30 may set the reference index of the spatially neighboring un-predicted block as the reference index for both of the TMVPs of the temporally neighboring block.

In this manner, determining the reference indices for the motion vectors of the current block when the motion vectors of the current block equal the TMVPs of a bi-predicted temporally neighboring block may be summarized as follows. Video encoder 20 and video decoder 30 may determine an index into RefPicList0 for the spatially neighboring block to the plurality of blocks and determine an index into RefPicList1 for the spatially neighboring block to the plurality of blocks.

If the index into RefPicList0 is not available, but the index into RefPicList1 is available, video encoder 20 and video decoder 30 may set the index into RefPicList0 equal to the index into RefPicList1. Otherwise, video encoder 20 and video decoder 30 may set the index into RefPicList0 equal to zero.

If the index into RefPicList1 is not available, but the index into RefPicList0 is available, video encoder 20 and video decoder 30 may set the index into RefPicList1 equal to the index into RefPicList0. Otherwise, video encoder 20 and video decoder 30 may set the index into RefPicList1 equal to zero.

In some examples, it may be possible that neither the index into RefPicList0 nor the index into RefPicList1 is available for the spatially neighboring block. For example, assume that the spatially neighboring block is intra-predicted. In this case, video encoder 20 and video decoder 30 may set the reference index for RefPicList0, RefPicList1, or both RefPicList0 and RefPicList1 equal to zero.

The above examples described the manner in which video encoder 20 and video decoder 30 determine reference index or indices for the current block in merge/skip mode when the motion vector or vectors for the current block are equal to the TMVP or TMVPs. In AMVP mode, video encoder 20 and video decoder 30 may not need to derive the reference index or indices for the current block. Rather, video encoder 20 may signal and video decoder 30 may receive the reference index or indices for the current block. However, in some examples, video encoder 20 and video decoder 30 may derive the reference index or indices for the current block in a manner similar to that described above with respect to the merge mode.

In some examples, in AMVP mode, video encoder 20 and video decoder 30 do not set the motion vector or vectors equal to the motion vector or vectors of the motion information. Rather, video encoder 20 signals in the coded bitstream and video decoder 30 receives from the coded bitstream a motion vector difference (MVD) between the actual motion vector or vectors of the current block and the motion vector or motion vectors of the selected motion information. Video encoder 20 and video decoder 30 utilize the MVD and the motion vector or vectors of the selected motion vector predictor information to determine the motion vector or vectors of the current block.

Also, in AMVP mode, video encoder 20 signals in the coded bitstream and video decoder 30 receives from the coded bitstream a reference index for the motion vector, if uni-predicted, or reference indices for the motion vectors, if bi-predicted. In this manner, video encoder 20 and video decoder 30 may not need to evaluate the reference index or indices of neighboring blocks, and instead signal in the coded bitstream or receive from the coded bitstream the reference index of indices for the reference picture or pictures for the motion vector or vectors of the current block.

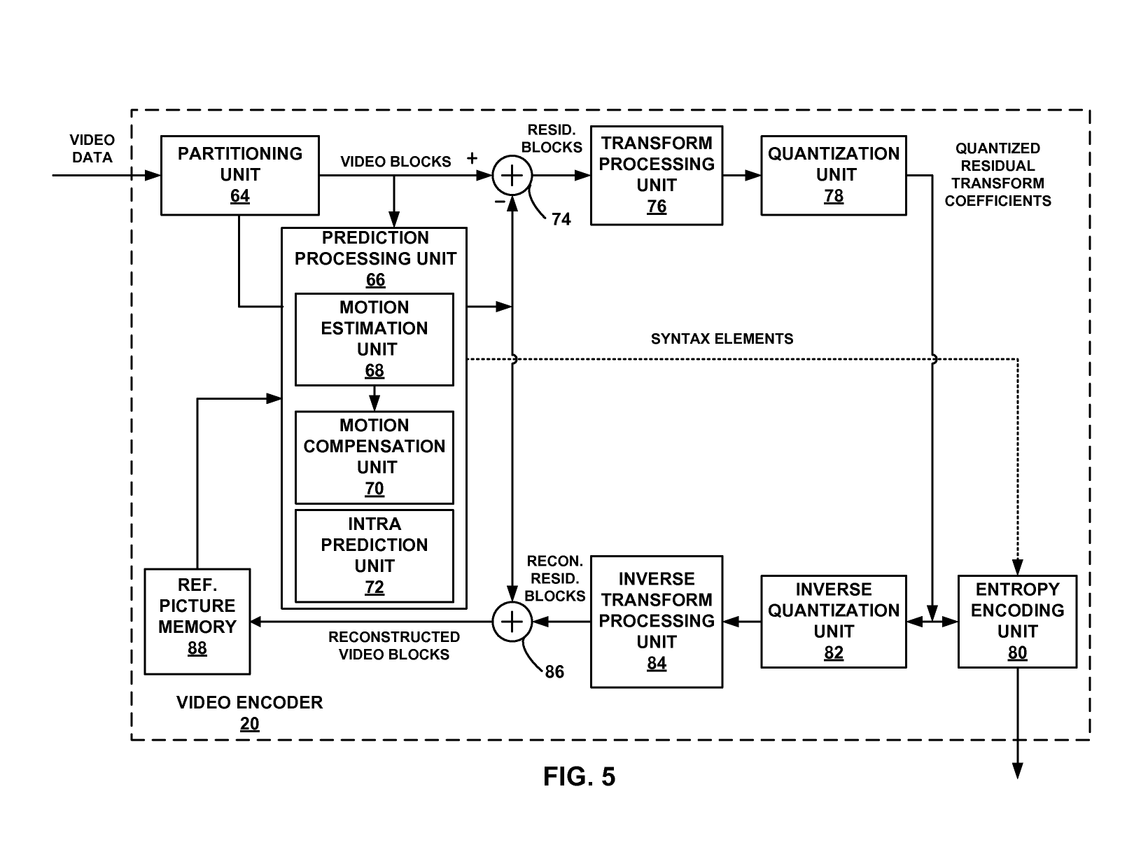

FIG. 5 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 5, video encoder 20 includes a partitioning unit 64, prediction processing unit 66, reference picture memory 88, summer 74, transform processing unit 76, quantization unit 78, and entropy encoding unit 80. Prediction processing unit 66 includes motion estimation unit 68, motion compensation unit 70, and intra prediction unit 72. For video block reconstruction, video encoder 20 also includes inverse quantization unit 82, inverse transform processing unit 84, and summer 86. A deblocking filter (not shown in FIG. 5) may also be included to filter block boundaries to remove blockiness artifacts from reconstructed video. If desired, the deblocking filter would typically filter the output of summer 86. Additional loop filters (in loop or post loop) may also be used in addition to the deblocking filter.

As shown in FIG. 5, video encoder 20 receives video data, and partitioning unit 64 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 66 may select one of a plurality of possible coding modes, such as one of a plurality of intra coding modes (i.e., intra-prediction) or one of a plurality of inter coding modes (i.e., inter-prediction), for the current video block based on error results (e.g., coding rate and the level of distortion). Prediction processing unit 66 may provide the resulting intra- or inter-coded block to summer 74 to generate residual block data and to summer 86 to reconstruct the encoded block for use as a reference picture.

Intra prediction unit 72 within prediction processing unit 66 may perform intra-predictive coding of the current video block relative to one or more neighboring blocks in the same frame or slice as the current block to be coded to provide spatial compression. Motion estimation unit 68 and motion compensation unit 70 within prediction processing unit 66 perform inter-predictive coding of the current video block relative to one or more predictive blocks in one or more reference pictures to provide temporal compression.

Motion estimation unit 68 may be configured to determine the inter-prediction mode for a video slice according to a predetermined pattern for a video sequence. Motion estimation unit 68 and motion compensation unit 70 may be highly integrated, but are illustrated separately for conceptual purposes. Motion estimation, performed by motion estimation unit 68, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 88. For example, video encoder 20 may interpolate values of one-quarter pixel positions, one-eighth pixel positions, or other fractional pixel positions of the reference picture. Therefore, motion estimation unit 68 may perform a motion search relative to the full pixel positions and fractional pixel positions and output a motion vector with fractional pixel precision.

Motion estimation unit 68 calculates a motion vector for a PU of a video block in an inter-coded slice by comparing the position of the PU to the position of a predictive block of a reference picture. The reference picture may be selected from a first reference picture list (RefPicList0) or a second reference picture list (RefPicList1), each of which identify one or more reference pictures stored in reference picture memory 88. Motion estimation unit 68 sends the calculated motion vector to entropy encoding unit 80 and motion compensation unit 70.

Motion compensation, performed by motion compensation unit 70, may involve fetching or generating the predictive block based on the motion vector determined by motion estimation, possibly performing interpolations to sub-pixel precision. Upon receiving the motion vector for the PU of the current video block, motion compensation unit 70 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 74 represents the component or components that perform this subtraction operation. Motion compensation unit 70 may also generate syntax elements associated with the video blocks and the video slice for use by video decoder 30 in decoding the video blocks of the video slice.

Intra-prediction unit 72 may intra-predict a current block, as an alternative to the inter-prediction performed by motion estimation unit 68 and motion compensation unit 70, as described above. In particular, intra-prediction unit 72 may determine an intra-prediction mode to use to encode a current block. In some examples, intra-prediction unit 72 may encode a current block using various intra-prediction modes, e.g., during separate encoding passes, and intra-prediction unit 72 may select an appropriate intra-prediction mode to use from the tested modes. For example, intra-prediction unit 72 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction unit 72 may calculate ratios from the distortions and rates for the various encoded blocks to determine which intra-prediction mode exhibits the best rate-distortion value for the block.

In any case, after selecting an intra-prediction mode for a block, intra-prediction unit 72 may provide information indicative of the selected intra-prediction mode for the block to entropy encoding unit 80. Entropy encoding unit 80 may encode the information indicating the selected intra-prediction mode in accordance with the techniques of this disclosure. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

After prediction processing unit 66 generates the predictive block for the current video block via either inter-prediction or intra-prediction, video encoder 20 forms a residual video block by subtracting the predictive block from the current video block. The residual video data in the residual block may be included in one or more TUs and applied to transform processing unit 76. Transform processing unit 76 transforms the residual video data into residual transform coefficients using a transform, such as a discrete cosine transform (DCT) or a conceptually similar transform. Transform processing unit 76 may convert the residual video data from a pixel domain to a transform domain, such as a frequency domain.

Transform processing unit 76 may send the resulting transform coefficients to quantization unit 78. Quantization unit 78 quantizes the transform coefficients to further reduce bit rate. The quantization process may reduce the bit depth associated with some or all of the coefficients. The degree of quantization may be modified by adjusting a quantization parameter. In some examples, quantization unit 78 may then perform a scan of the matrix including the quantized transform coefficients. Alternatively, entropy encoding unit 80 may perform the scan.

Following quantization, entropy encoding unit 80 entropy encodes the quantized transform coefficients. For example, entropy encoding unit 80 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 80, the encoded bitstream may be transmitted to video decoder 30, or archived for later transmission or retrieval by video decoder 30. Entropy encoding unit 80 may also entropy encode the motion vectors and the other syntax elements for the current video slice being coded.

Inverse quantization unit 82 and inverse transform processing unit 84 apply inverse quantization and inverse transformation, respectively, to reconstruct the residual block in the pixel domain for later use as a reference block of a reference picture. Motion compensation unit 70 may calculate a reference block by adding the residual block to a predictive block of one of the reference pictures within one of the reference picture lists. Motion compensation unit 70 may also apply one or more interpolation filters to the reconstructed residual block to calculate sub-integer pixel values for use in motion estimation. Summer 86 adds the reconstructed residual block to the motion compensated prediction block produced by motion compensation unit 70 to produce a reference block for storage in reference picture memory 88. The reference block may be used by motion estimation unit 68 and motion compensation unit 70 as a reference block to inter-predict a block in a subsequent video frame or picture.

In some examples, prediction processing unit 66 may be configured to perform the techniques of this disclosure. However, aspects of this disclosure are not so limited. In other examples, some other unit of video encoder 20, such as a processor, or any other unit of video encoder 20 may be tasked to perform the techniques of this disclosure. Also, in some examples, the techniques of this disclosure may be divided among one or more of the units of video encoder 20.

For example, prediction processing unit 66 may be configured to determine motion information for a block in a temporal picture, where the block in the temporal picture temporally neighbors a plurality of blocks in the current picture. Prediction processing unit 66 may determine this motion information for the temporally neighboring block only once, and include this motion information in the list of candidate motion vector predictors for each block of the plurality of blocks.

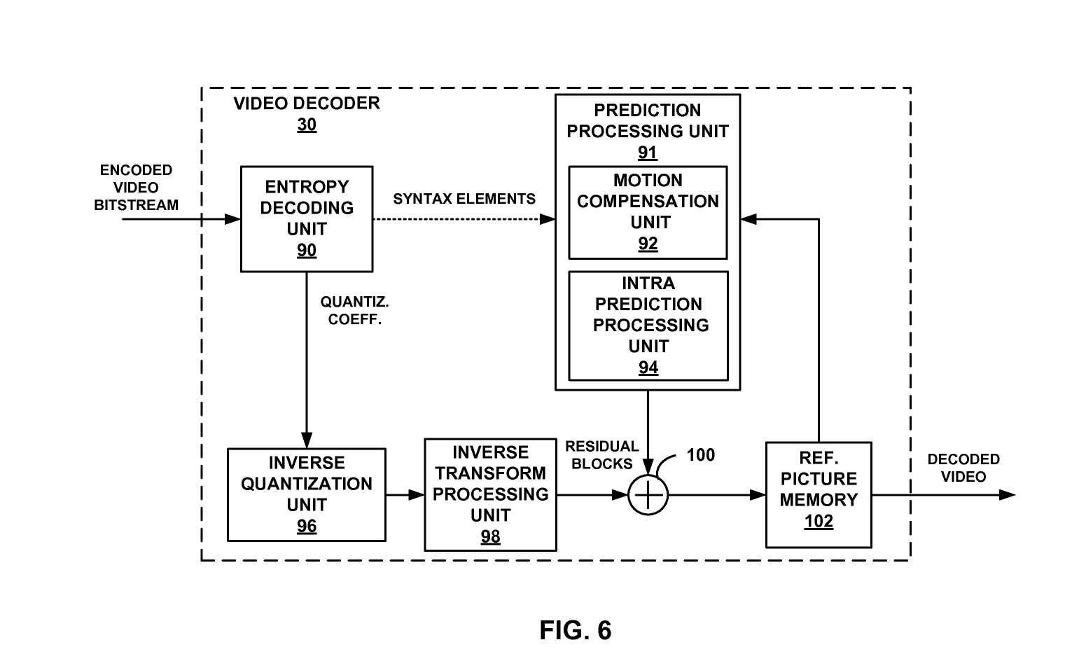

FIG. 6 is a block diagram illustrating an example video decoder 30 that may implement the techniques described in this disclosure. In the example of FIG. 3, video decoder 30 includes an entropy decoding unit 90, prediction processing unit 91, inverse quantization unit 96, inverse transformation unit 98, summer 100, and reference picture memory 102. Prediction processing unit 91 includes motion compensation unit 92 and intra prediction unit 94. Video decoder 30 may, in some examples, perform a decoding pass generally reciprocal to the encoding pass described with respect to video encoder 20 from FIG. 5.

During the decoding process, video decoder 30 receives an encoded video bitstream that represents video blocks of an encoded video slice and associated syntax elements from video encoder 20. Entropy decoding unit 90 of video decoder 30 entropy decodes the bitstream to generate quantized coefficients, motion vectors, and other syntax elements. Entropy decoding unit 90 forwards the motion vectors and other syntax elements to prediction processing unit 91. Video decoder 30 may receive the syntax elements at the video slice level and/or the video block level.

When the video slice is coded as an intra-coded (I) slice, intra prediction unit 94 of prediction processing unit 91 may generate prediction data for a video block of the current video slice based on a signaled intra prediction mode and data from previously decoded blocks of the current frame or picture. When the video picture is coded as an inter-coded (i.e., B or P) slice, motion compensation unit 92 of prediction processing unit 91 produces predictive blocks for a video block of the current video slice based on the motion vectors and other syntax elements received from entropy decoding unit 90. The predictive blocks may be produced from one of the reference pictures within one of the reference picture lists. Video decoder 30 may construct the reference picture lists, RefPicList0 and RefPicList1, using default construction techniques or any other technique based on reference pictures stored in reference picture memory 102.

Motion compensation unit 92 determines prediction information for a video block of the current video slice by parsing the motion vectors and other syntax elements, and uses the prediction information to produce the predictive blocks for the current video block being decoded. For example, motion compensation unit 92 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 92 may also perform interpolation based on interpolation filters. Motion compensation unit 92 may use interpolation filters as used by video encoder 20 during encoding of the video blocks to calculate interpolated values for sub-integer pixels of reference blocks. In this case, motion compensation unit 92 may determine the interpolation filters used by video encoder 20 from the received syntax elements and use the interpolation filters to produce predictive blocks.

Inverse quantization unit 96 inverse quantizes (i.e., de-quantizes), the quantized transform coefficients provided in the bitstream and decoded by entropy decoding unit 90. The inverse quantization process may include use of a quantization parameter calculated by video encoder 20 for each video block in the video slice to determine a degree of quantization and, likewise, a degree of inverse quantization that should be applied. Inverse transform processing unit 98 applies an inverse transform, e.g., an inverse DCT, an inverse integer transform, or a conceptually similar inverse transform process, to the transform coefficients in order to produce residual blocks in the pixel domain.

After motion compensation unit 92 generates the predictive block for the current video block based on the motion vectors and other syntax elements, video decoder 30 forms a decoded video block by summing the residual blocks from inverse transform processing unit 98 with the corresponding predictive blocks generated by motion compensation unit 92. Summer 100 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 102, which stores reference pictures used for subsequent motion compensation. Reference picture memory 102 also stores decoded video for later presentation on a display device, such as display device 32 of FIG. 1.

In some examples, prediction processing unit 91 may be configured to perform the techniques of this disclosure. However, aspects of this disclosure are not so limited. In other examples, some other unit of video encoder 30, such as a processor, or any other unit of video encoder 30 may be tasked to perform the techniques of this disclosure. Also, in some examples, the techniques of this disclosure may be divided among one or more of the units of video encoder 30.

For example, prediction processing unit 91 may be configured to determine motion information for a block in a temporal picture, where the block in the temporal picture temporally neighbors a plurality of blocks in the current picture. Prediction processing unit 91 may determine this motion information for the temporally neighboring block only once, and include this motion information in the list of candidate motion vector predictors for each block of the plurality of blocks.

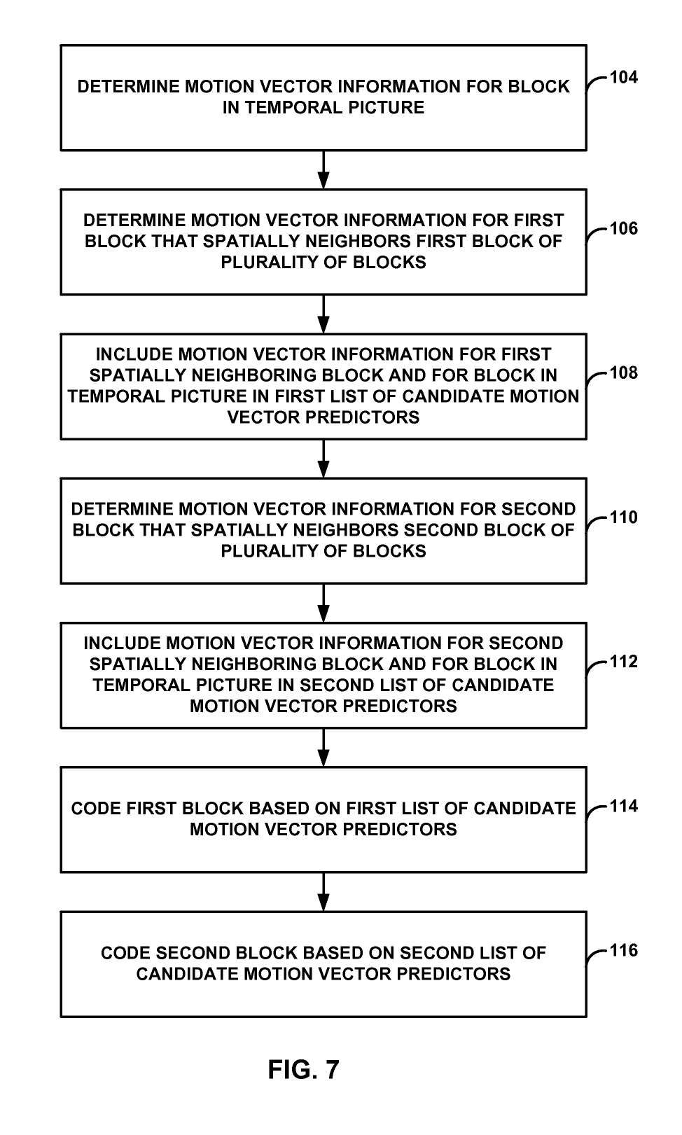

FIG. 7 is a flowchart illustrating an example operation in accordance with one or more example techniques described in this disclosure. A video coder may be configured to implement the example techniques illustrated in FIG. 7. Examples of the video coder include video encoder 20 and video decoder 30.

As illustrated in FIG. 7, the video coder may determine motion information for a block in a temporal picture, where the block in the temporal picture temporally neighbors a plurality of blocks in a current picture (104). For example, the video coder may determine the motion vector information (e.g., information for the motion vector or vectors of the block in the temporal picture), the reference index information (e.g., information for the reference index or indices that indicate the picture or pictures to which the motion vector or vectors of the block in the temporal picture refer), or both the motion vector information and the reference index information. The video coder may determine the motion information for the block in the temporal picture only once for all blocks of the plurality of blocks.

The video coder may determine motion information for a first block that spatially neighbors a first block of the plurality of blocks (106). For example, the video coder may determine the motion information for a spatially neighboring block of the first block of the plurality of blocks.

In FIG. 7, the video coder may include the motion information, if available, for the first block that spatially neighbors the first block of the plurality of blocks and the motion information for the block in the temporal picture in a first list of candidate motion vector predictors for the first block of the plurality of blocks (108). In some examples, there may not be motion information for the first block that spatially neighbors the first block of the plurality of blocks. In these examples, the video coder may include the motion information for the first block that spatially neighbors the first block of the plurality of blocks if the motion information is available, and not if the motion information is not available.

Also, it should be understood that when scaling of the motion information for the block in the temporal picture is needed, the video coder including the motion information for the block in the temporal picture may include the examples of the video coder including the scaled motion information for the block in the temporal picture. The video coder may construct the list of candidate motion vector predictors for the first block by including the motion information of the spatially neighboring block and the motion information for the block that temporally neighbors the plurality of blocks.

The video coder may determine motion information for a second block that spatially neighbors a second block of the plurality of blocks (110). For example, the video coder may determine the motion information for a spatially neighboring block of the second block of the plurality of blocks. In some examples, the block that spatially neighbors the second block of the plurality of the blocks may be different than the block that spatially neighbors the first block of the plurality of blocks.

Similar to above, the video coder may include the motion information, if available, for the second block that spatially neighbors the second block of the plurality of blocks and the motion information for the block in the temporal picture in a second list of candidate motion vector predictors for the second block of the plurality of blocks (112). In some examples, there may not be motion information for the second block that spatially neighbors the second block of the plurality of blocks. In these examples, the video coder may include the motion information for the second block that spatially neighbors the second block of the plurality of blocks if the motion information is available, and not if the motion information is not available.

Again, as above, it should be understood that when scaling of the motion information for the block in the temporal picture is needed, the video coder including the motion information for the block in the temporal picture may include the examples of the video coder including the scaled motion information for the block in the temporal picture. The video coder may construct the list of candidate motion vector predictors for the second block by including the motion information of the spatially neighboring block and the motion information for the block that temporally neighbors the plurality of blocks.

In this example, because the spatially neighboring block of the first block of the plurality of blocks is different than the spatially neighboring block of the second block of the plurality of blocks, the SMVPs for the first list of candidate motion vector predictors may be different than the SMVPs for the second list of candidate motion vector predictors. However, the TMVP for the both the first list and second list of candidate motion vector predictors is the same. Accordingly, the video coder may determine the SMVPs on a block-by-block basis for the blocks in the plurality of blocks, but may determine the TMVP as a common TMVP for all blocks in the plurality of blocks. This may allow the video coder to determine the TMVP only once for the plurality of blocks, which may promote less complex and processing efficient inter-prediction.

The video coder may code the first block of the plurality of blocks based on the first list of candidate motion vector predictors (114). The video coder may also code the second block of the plurality of blocks based on the second list of candidate motion vector predictors (116). For example, the video coder may implement one of the merge/skip mode and the advanced motion vector prediction (AMVP) mode to code the first block based on the first list of candidate motion vector predictors, or the second block based on the second list of candidate motion vector predictors.

In some examples, the video coder may determine the location of the block in the temporal picture based on a formation of the plurality of blocks. In some examples, the video coder may determine the location of the block in the temporal picture regardless of a formation of the plurality of blocks.

The formation of the plurality of blocks may indicate a partition mode. As one example, the plurality of blocks may form a coding unit (CU), and the first block and the second block, in FIG. 7, may be a first prediction unit (PU) of the CU and a second PU of the CU, respectively. As another example, the plurality of blocks may form a largest coding unit (LCU), and the first block and the second block, in FIG. 7, may be a first CU of the LCU and a second CU of the LCU.

In some examples, the video coder may determine the location of the block in the temporal picture based on partition mode of the CU or LCU. For example, the partition mode of the CU or LCU may determine whether the block in the temporal picture is located in a first, second, third, or fourth location, as described above with respect to FIGS. 4A-4D. In some examples, the video coder may determine the location of the block in the temporal picture regardless of the partition mode of the CU or LCU. For example, as illustrated in FIGS. 3A-3I, the location of the block in the temporal picture is fixed regardless of the manner in which the CU or LCU is partitioned.

Moreover, as part of merge/skip mode, the video coder may determine the reference index or indices for the motion vector or vectors of the block in the temporal picture. In some examples, if the block in the temporal picture is bi-predicted with a first motion vector and a second motion vector, and a spatially neighboring block that neighbors the plurality of blocks is uni-predicted, the video coder may set the reference indices for the first and second motion vectors equal to the reference index of the motion vector for the uni-predicted spatially neighboring block that neighbors the plurality of blocks.

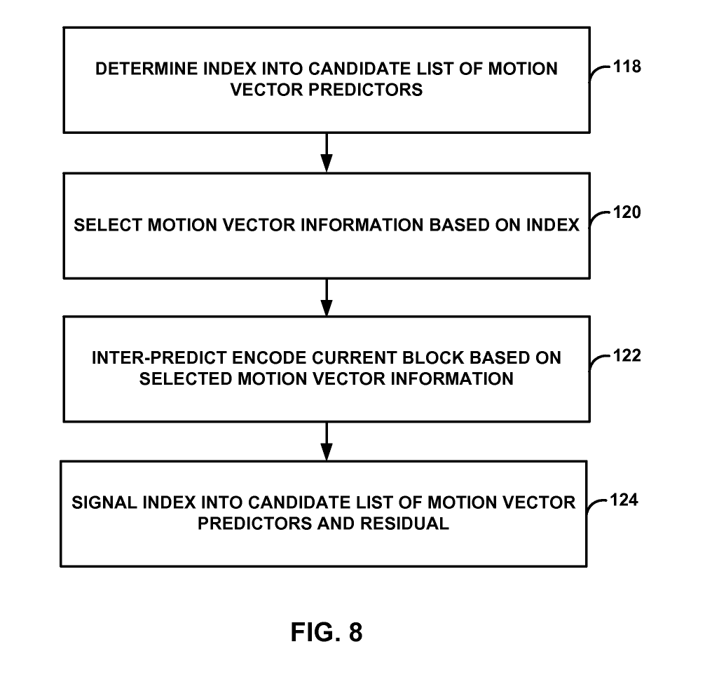

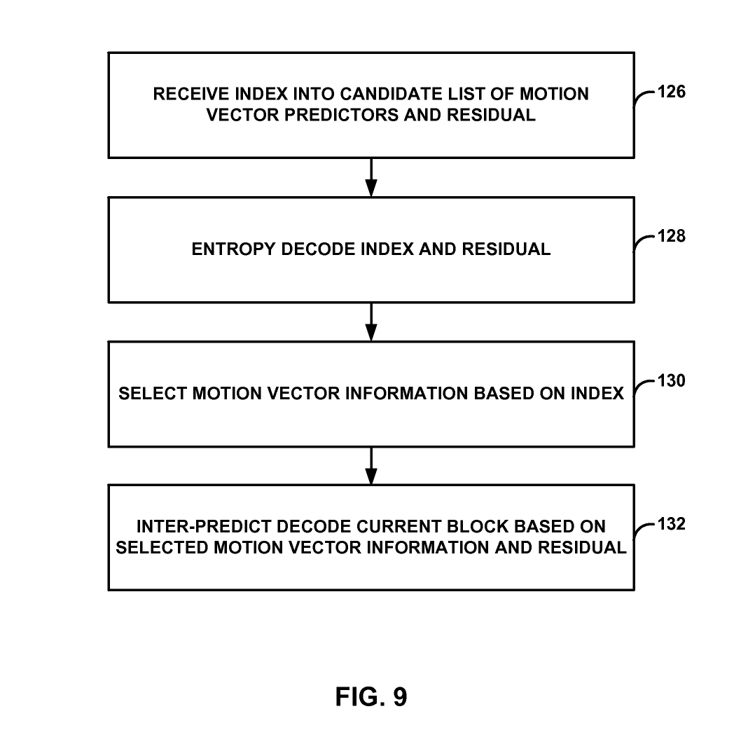

FIG. 8 is a flowchart illustrating another example operation in accordance with one or more example techniques described in this disclosure. FIG. 9 is a flowchart illustrating another example operation in accordance with one or more example techniques described in this disclosure. For example, as described above with respect to FIG. 7, the video coder may code the first block based on the first list of candidate motion vector predictors, and may code the second block based on the second list of candidate motion vector predictors.

FIG. 8 illustrates an example of such coding by video encoder 20, and FIG. 9 illustrates an example of such coding by video decoder 30. Both FIGS. 8 and 9 are described with respect to the merge mode. However, the techniques described in FIGS. 8 and 9 are also extendable to the AMVP mode, where video encoder 20 signals MVDs and reference indices in the coded bitstream, and video decoder 30 receives the MVDs and reference indices from the coded bitstream for the current block.

As illustrated in FIG. 8, video encoder 20 may determine an index into the candidate list of motion vector predictors for a current block (118). Video encoder 20 may select the motion information in the candidate list of motion vector predictors based on the determined index (120).

Video encoder 20 may inter-predict encode the current block based on the selected motion information (122). For example, in merge mode, video encoder 20 may set the SMVPs and TMPVs as the motion vectors for the current block. If the selected motion information is for a spatially neighboring block, video encoder 20 may set the reference indices of the selected motion information as the reference indices of the SMVPs. If the selected motion information is for the temporally neighboring block, video encoder 20 may derive the reference indices and set the derived reference indices as the reference indices of the TMVPs.

Video encoder 20 may signal the index into the candidate list of motion vector predictors and the residual between the block used for inter-prediction and the current block (124). For example, video encoder 20 may select the block used for inter-predicting the current block based on the selected motion information, and signal the difference between the pixel values of the block used for inter-prediction and the current block. In some examples, video encoder 20 may entropy encode the index into the candidate list of motion vector predictors and the residual prior to signaling.

As illustrated in FIG. 9, video decoder 30 may receive an index into the candidate list of motion vector predictors for the current block and the residual between the current block and the block used for inter-prediction (126). The index into the candidate list of motion vector predictors and the residual may have been entropy encoded. Accordingly, video decoder 30 may entropy decode the index into the candidate list of motion vector predictors and the residual (128).

Video decoder 30 may select motion information based on the index into the list of candidate motion vector predictors (130). Video decoder 30 may inter-predict decode the current block based on the selected motion information and residual (132). For example, video decoder 30 may determine the block that is to be used for inter-predicting the current block based on the selected motion information. Video decoder 30 may then add the residual to the pixel values of the block that is to be used for inter-predicting the current block to determine the pixel values of the current block.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for coding video data, the method comprising:
determining motion information for a block in a temporal picture, wherein the block in the temporal picture temporally neighbors a plurality of blocks in a current picture;
determining motion information for a first block that spatially neighbors a first block of the plurality of blocks;
including the motion information, if available, for the first block that spatially neighbors the first block of the plurality of blocks and the motion information for the block in the temporal picture in a first list of candidate motion vector predictors for the first block of the plurality of blocks;
determining motion information for a second, different block that spatially neighbors a second, different block of the plurality of blocks;
including the motion information, if available, for the second block that spatially neighbors the second block of the plurality of blocks and the motion information for the block in the temporal picture in a second, different list of candidate motion vector predictors for the second block of the plurality of blocks;
coding the first block of the plurality of blocks based on the first list of candidate motion vector predictors; and
coding the second block of the plurality of blocks based on the second list of candidate motion vector predictors.

2. The method of claim 1, wherein determining the motion information for the block in the temporal picture comprises determining the motion information for the block in the temporal picture only once for all blocks of the plurality of blocks.

3. The method of claim 1, further comprising:
determining a location of the block in the temporal picture based on a formation of the plurality of blocks.

4. The method of claim 1, further comprising:
determining a location of the block in the temporal picture regardless of a formation of the plurality of blocks.

5. The method of claim 1, wherein the plurality of blocks form a coding unit (CU), wherein the first block of the plurality of blocks comprises a first prediction unit (PU) of the CU, and wherein the second block of the plurality of blocks comprises a second PU of the CU.

6. The method of claim 1, wherein the plurality of blocks form a large coding unit (LCU), wherein the first block of the plurality of blocks comprises a first coding unit (CU) of the LCU, and wherein the second block of the plurality of blocks comprises a second CU of the LCU.

7. The method of claim 1, wherein the block in the temporal picture is bi-predicted with respect to a first motion vector and a second motion vector, the method further comprising:
determining whether a block that spatially neighbors the plurality of blocks is uni-predicted with one motion vector; and
when the block that spatially neighbors the plurality of blocks is uni-predicted with one motion vector, setting a reference index of the first motion vector into a first reference picture list equal to a reference index of the motion vector of the block that spatially neighbors the plurality of blocks, and setting a reference index of the second motion vector into a second reference picture list equal to the reference index of the motion vector of the block that spatially neighbors the plurality of blocks.

8. The method of claim 1, wherein coding the first block comprises implementing one of merge/skip mode and advanced motion vector prediction (AMVP) mode based on the first list of candidate motion vector predictors, and wherein coding the second block comprises implementing one of the merge/skip mode and AMVP mode based on the second list of candidate motion vector predictors.

9. The method of claim 1,
wherein determining the motion information for the block in the temporal picture comprises determining, with a video decoder, the motion information for the block in the temporal picture,
wherein determining the motion information for the first block that spatially neighbors the first block of the plurality of blocks comprises determining, with the video decoder, the motion information for the first block that spatially neighbors the first block of the plurality of blocks,
wherein including the motion information comprises including, with the video decoder, the motion information, if available, for the first block that spatially neighbors the first block of the plurality of blocks and the motion information for the block in the temporal picture in a first list of candidate motion vector predictors for the first block of the plurality of blocks,
wherein determining the motion information for the second, different block that spatially neighbors the second, different block of the plurality of blocks comprises determining, with the video decoder, the motion information for the second, different block that spatially neighbors the second, different block of the plurality of blocks,
wherein including the motion information comprises including, with the video decoder, the motion information, if available, for the second block that spatially neighbors the second block of the plurality of blocks and the motion information for the block in the temporal picture in a second, different list of candidate motion vector predictors for the second block of the plurality of blocks,
wherein coding comprises decoding, with the video decoder, the first block of the plurality of blocks based on the first list of candidate motion vector predictors, and
wherein coding comprises decoding, with the video decoder, the second block of the plurality of blocks based on the second list of candidate motion vector predictors.

10. The method of claim 1,
wherein determining the motion information for the block in the temporal picture comprises determining, with a video encoder, the motion information for the block in the temporal picture,
wherein determining the motion information for the first block that spatially neighbors the first block of the plurality of blocks comprises determining, with the video encoder, the motion information for the first block that spatially neighbors the first block of the plurality of blocks,
wherein including the motion information comprises including, with the video encoder, the motion information, if available, for the first block that spatially neighbors the first block of the plurality of blocks and the motion information for the block in the temporal picture in a first list of candidate motion vector predictors for the first block of the plurality of blocks,
wherein determining the motion information for the second, different block that spatially neighbors the second, different block of the plurality of blocks comprises determining, with the video encoder, the motion information for the second, different block that spatially neighbors the second, different block of the plurality of blocks,
wherein including the motion information comprises including, with the video encoder, the motion information, if available, for the second block that spatially neighbors the second block of the plurality of blocks and the motion information for the block in the temporal picture in a second, different list of candidate motion vector predictors for the second block of the plurality of blocks,
wherein coding comprises encoding, with the video encoder, the first block of the plurality of blocks based on the first list of candidate motion vector predictors, and
wherein coding comprises encoding, with the video encoder, the second block of the plurality of blocks based on the second list of candidate motion vector predictors.

11. A device for coding video data, the device comprising a video coder configured to:
determine motion information for a block in a temporal picture, wherein the block in the temporal picture temporally neighbors a plurality of blocks in a current picture;
determine motion information for a first block that spatially neighbors a first block of the plurality of blocks;
include the motion information, if available, for the first block that spatially neighbors the first block of the plurality of blocks and the motion information for the block in the temporal picture in a first list of candidate motion vector predictors for the first block of the plurality of blocks;
determine motion information for a second, different block that spatially neighbors a second, different block of the plurality of blocks;
include the motion information, if available, for the second block that spatially neighbors the second block of the plurality of blocks and the motion information for the block in the temporal picture in a second, different list of candidate motion vector predictors for the second block of the plurality of blocks;
code the first block of the plurality of blocks based on the first list of candidate motion vector predictors; and
code the second block of the plurality of blocks based on the second list of candidate motion vector predictors.

12. The device of claim 11, wherein the video coder is configured to determine the motion information for the block in the temporal picture only once for all blocks of the plurality of blocks.

13. The device of claim 11, wherein the video coder is configured to determine a location of the block in the temporal picture based on a formation of the plurality of blocks.

14. The device of claim 11, wherein the video coder is configured to determine a location of the block in the temporal picture regardless of a formation of the plurality of blocks.

15. The device of claim 11, wherein the plurality of blocks form a coding unit (CU), wherein the first block of the plurality of blocks comprises a first prediction unit (PU) of the CU, and wherein the second block of the plurality of blocks comprises a second PU of the CU.

16. The device of claim 11, wherein the plurality of blocks form a large coding unit (LCU), wherein the first block of the plurality of blocks comprises a first coding unit (CU) of the LCU, and wherein the second block of the plurality of blocks comprises a second CU of the LCU.

17. The device of claim 11, wherein the block in the temporal picture is bi-predicted with respect to a first motion vector and a second motion vector, and wherein the video coder is configured to:
determine whether a block that spatially neighbors the plurality of blocks is un-predicted with one motion vector; and
when the block that spatially neighbors the plurality of blocks is uni-predicted with one motion vector, set a reference index of the first motion vector into a first reference picture list equal to a reference index of the motion vector of the block that spatially neighbors the plurality of blocks, and set a reference index of the second motion vector into a second reference picture list equal to the reference index of the motion vector of the block that spatially neighbors the plurality of blocks.

18. The device of claim 11, wherein, to code the first block, the video coder is configured to implement one of merge/skip mode and advanced motion vector prediction (AMVP) mode based on the first list of candidate motion vector predictors, and wherein, to code the second block, the video coder is configured to implement one of the merge/skip mode and AMVP mode based on the second list of candidate motion vector predictors.

19. The device of claim 11, wherein the video coder comprises a video decoder, and wherein the video decoder is configured to:
determine the motion information for the block in a temporal picture, wherein the block in the temporal picture temporally neighbors the plurality of blocks in a current picture;
determine the motion information for the first block that spatially neighbors the first block of the plurality of blocks;
include the motion information, if available, for the first block that spatially neighbors the first block of the plurality of blocks and the motion information for the block in the temporal picture in the first list of candidate motion vector predictors for the first block of the plurality of blocks;
determine the motion information for the second, different block that spatially neighbors the second, different block of the plurality of blocks;
include the motion information, if available, for the second block that spatially neighbors the second block of the plurality of blocks and the motion information for the block in the temporal picture in the second, different list of candidate motion vector predictors for the second block of the plurality of blocks;
decode the first block of the plurality of blocks based on the first list of candidate motion vector predictors; and
decode the second block of the plurality of blocks based on the second list of candidate motion vector predictors.

20. The device of claim 11, wherein the video coder comprises a video encoder, and wherein the video encoder is configured to:
determine the motion information for the block in a temporal picture, wherein the block in the temporal picture temporally neighbors the plurality of blocks in a current picture;
determine the motion information for the first block that spatially neighbors the first block of the plurality of blocks;
include the motion information, if available, for the first block that spatially neighbors the first block of the plurality of blocks and the motion information for the block in the temporal picture in the first list of candidate motion vector predictors for the first block of the plurality of blocks;
determine the motion information for the second, different block that spatially neighbors the second, different block of the plurality of blocks;
include the motion information, if available, for the second block that spatially neighbors the second block of the plurality of blocks and the motion information for the block in the temporal picture in the second, different list of candidate motion vector predictors for the second block of the plurality of blocks;
encode the first block of the plurality of blocks based on the first list of candidate motion vector predictors; and
encode the second block of the plurality of blocks based on the second list of candidate motion vector predictors.

21. The device of claim 11, wherein the device comprises one of:
a wireless communication device;
a microprocessor; and
an integrated circuit.

22. A device for coding video data, the device comprising:
means for determining motion information for a block in a temporal picture, wherein the block in the temporal picture temporally neighbors a plurality of blocks in a current picture;
means for determining motion information for a first block that spatially neighbors a first block of the plurality of blocks;
means for including, if available, the motion information for the first block that spatially neighbors the first block of the plurality of blocks and the motion information for the block in the temporal picture in a first list of candidate motion vector predictors for the first block of the plurality of blocks;
means for determining motion information for a second, different block that spatially neighbors a second, different block of the plurality of blocks;
means for including, if available, the motion information for the second block that spatially neighbors the second block of the plurality of blocks and the motion information for the block in the temporal picture in a second, different list of candidate motion vector predictors for the second block of the plurality of blocks;
means for coding the first block of the plurality of blocks based on the first list of candidate motion vector predictors; and
means for coding the second block of the plurality of blocks based on the second list of candidate motion vector predictors.

23. The device of claim 22, wherein the means for determining the motion information for the block in the temporal picture comprises means for determining the motion information for the block in the temporal picture only once for all blocks of the plurality of blocks.

24. The device of claim 22, wherein the plurality of blocks form a coding unit (CU), wherein the first block of the plurality of blocks comprises a first prediction unit (PU) of the CU, and wherein the second block of the plurality of blocks comprises a second PU of the CU.

25. The device of claim 22, wherein the plurality of blocks form a large coding unit (LCU), wherein the first block of the plurality of blocks comprises a first coding unit (CU) of the LCU, and wherein the second block of the plurality of blocks comprises a second CU of the LCU.

26. A computer-readable storage medium having instructions stored thereon that when executed cause one or more processors to:
determine motion information for a block in a temporal picture, wherein the block in the temporal picture temporally neighbors a plurality of blocks in a current picture;
determine motion information for a first block that spatially neighbors a first block of the plurality of blocks;
include the motion information, if available, for the first block that spatially neighbors the first block of the plurality of blocks and the motion information for the block in the temporal picture in a first list of candidate motion vector predictors for the first block of the plurality of blocks;
determine motion information for a second, different block that spatially neighbors a second, different block of the plurality of blocks;
include the motion information, if available, for the second block that spatially neighbors the second block of the plurality of blocks and the motion information for the block in the temporal picture in a second, different list of candidate motion vector predictors for the second block of the plurality of blocks;
code the first block of the plurality of blocks based on the first list of candidate motion vector predictors; and
code the second block of the plurality of blocks based on the second list of candidate motion vector predictors.

27. The computer-readable storage medium of claim 26, wherein the instructions that cause the one or more processors to determine the motion information for the block in the temporal picture comprise instructions that cause the one or more processors to determine the motion information for the block in the temporal picture only once for all blocks of the plurality of blocks.
